(19) United States
(12) Patent Application Publication
(10) Pub. No.: US 2025/0390832 A1
(43) Pub. Date: Dec. 25, 2025

(54) Adjusting Signals to Shift System Resource Utilization

(71) Applicant: Uber Technologies, Inc., San Francisco, CA (US)

(72) Inventors: Marcio de Castro Marques, Toronto (CA); Emre Demiralp, San Francisco, CA (US); Cemil Dibek, Jersey City, NJ (US); Dinkar Jain, Menlo Park, CA (US); Noah Shaw, San Francisco, CA (US); Harshini Singh, San Francisco, CA (US); Tong Tong, Scarborough (CA)

(21) Appl. No.: 18/749,304

(22) Filed: Jun. 20, 2024

(51) Int. Cl. G06Q 10/0835

(52) U.S. Cl. CPC G06Q 10/08355

(57) ABSTRACT

Example aspects of the present disclosure relate to demand shaping by adjusting signals to shift system resource utilization. An example method includes accessing data associated with batched service instances for a batch delivery window. The method includes determining a probability that a user initiates a service instance outside of the batch delivery window is greater than a probability for initiating the service instance within the window. Responsive to determining the first probability is greater than the second probability, determining an incentive predicted to increase the probability of the service instance within the batch delivery window. The method includes generating a selectable user interface element including an indication of the incentive associated with the batch delivery window. The method includes automatically updating the user interface responsive to selection of the user interface to provide the incentive for display alongside a number of available items associated with the batch delivery window.

### FIELD

The present disclosure generally relates to performing demand shaping by adjusting signals to shift system resource utilization for routing precomputed batched routes.

### BACKGROUND

Delivery services can be performed in real-time or can be precomputed for a future instance. For instance, a user can request, through a delivery service application, a delivery to be performed in real-time such as, for example, to deliver a perishable food item. In addition, a user can request, through the delivery service application, a delivery to be performed in the near future such as, for example, to deliver non-perishable items. Courier efficiency can be improved by routing a courier along a batched route to simultaneously perform both real-time and batched deliveries.

### SUMMARY

Aspects and advantages of embodiments of the present disclosure will be set forth in part in the following description, or can be learned from the description, or can be learned through practice of the embodiments.

One example aspect of the present disclosure is directed to a computing system. The computing system includes one or more processors and one or more tangible, non-transitory, computer-readable media that store instructions that are executable by the one or more processors to cause the computing system to perform operations. The operations include accessing data associated with a number of batched service instances for a first batch delivery window, the data including at least a first service instance including a pick-up location, a drop-off location, and a drop-off time range. The drop-off time range is within the first batch delivery window. The operations include determining a first probability that a first device identifier initiates a second service instance associated with the pick-up location outside of the first batch delivery window is greater than a second probability that the first device identifier initiates the second service instance associated with the pick-up location within the first batch delivery window. The operations include responsive to determining that the first probability is less than the second probability, determining a selected incentive predicted to increase probability associated with initiating the second service instance associated with the pick-up location within the first batch delivery window. The operations include generating a selectable user interface element including an indication of the incentive associated with the first batch delivery window. The operations include responsive to obtaining data indicative of selection of the user interface element, automatically updating the user interface associated with a user device to launch a secondary user interface associated with a service application such that the incentive is provided for display alongside a number of available items associated with the first batch delivery window.

Another example aspect of the present disclosure is directed to a computer-implemented method. The method includes accessing data associated with a number of batched service instances for a first batch delivery window, the data including at least a first service instance including a pick-up location, a drop-off location, and a drop-off time range. The drop-off time range is within the first batch delivery window. The method includes determining a first probability that a first device identifier initiates a second service instance associated with the pick-up location outside of the first batch delivery window is greater than a second probability that the first device identifier initiates the second service instance associated with the pick-up location within the first batch delivery window. The method includes responsive to determining that the first probability is less than the second probability, determining a selected incentive predicted to increase probability associated with initiating the second service instance associated with the pick-up location within the first batch delivery window. The method includes generating a selectable user interface element including an indication of the incentive associated with the first batch delivery window. The method includes responsive to obtaining data indicative of selection of the user interface element, automatically updating the user interface associated with a user device to launch a secondary user interface associated with a service application such that the incentive is provided for display alongside a number of available items associated with the first batch delivery window.

Yet another example aspect of the present disclosure is directed to one or more non-transitory computer readable media storing instructions that are executable by one or more processors to perform operations. The operations include accessing data associated with a number of batched service instances for a first batch delivery window, the data including at least a first service instance including a pick-up location, a drop-off location, and a drop-off time range. The drop-off time range is within the first batch delivery window. The operations include determining a first probability that a first device identifier initiates a second service instance associated with the pick-up location outside of the first batch delivery window is greater than a second probability that the first device identifier initiates the second service instance associated with the pick-up location within the first batch delivery window. The operations include responsive to determining that the first probability is less than the second probability, determining a selected incentive predicted to increase probability associated with initiating the second service instance associated with the pick-up location within the first batch delivery window. The operations include generating a selectable user interface element including an indication of the incentive associated with the first batch delivery window. The operations include responsive to obtaining data indicative of selection of the user interface element, automatically updating the user interface associated with a user device to launch a secondary user interface associated with a service application such that the incentive is provided for display alongside a number of available items associated with the first batch delivery window.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system according to aspects of the present disclosure.

FIG. 2 depicts a block diagram of an example data pipeline according to aspects of the present disclosure.

FIG. 3 depicts a block diagram of an example data pipeline according to aspects of the present disclosure.

FIG. 4 depicts a block diagram of example data according to example embodiments of the present disclosure.

FIG. 5 depicts exemplary paths for a particular geographic area during a particular time according to aspects of the present disclosure.

FIG. 6 depicts an example graphical depiction of a batched assignment compared to individual assignments according to example embodiments of the present disclosure.

FIG. 7 depicts an example batched assignment route according to example embodiments of the present disclosure.

FIG. 8 depicts an example graphical user interface according to example embodiments of the present disclosure.

FIG. 9 depicts an example graphical user interface according to example embodiments of the present disclosure.

FIG. 10 depicts an example graphical user interface according to example embodiments of the present disclosure.

FIG. 11 depicts a flowchart of an example method according to example embodiments of the present disclosure.

FIG. 12 depicts a flowchart of an example method according to example embodiments of the present disclosure.

FIG. 13 depicts a block diagram for a hybrid delivery system according to aspects of the present disclosure.

FIG. 14 depicts a block diagram of an example system according to example embodiments of the present disclosure.

FIG. 15 depicts a block diagram of an example system according to example embodiments of the present disclosure.

### DETAILED DESCRIPTION

The present disclosure generally relates to a method for improving the predictability and efficiency of a distributed computing ecosystem. More particularly, the technology described herein allows for intelligent batching of computing resources utilized to process a complex service that includes multiple distributed computing devices—e.g., a computer-based delivery service. For example, the technology allows a network computing system to batch its computing resources more efficiently by intelligently increasing demand for deliveries for discrete time windows or areas to provide for more efficient supply of products or services. This can include determining expected demand and automatically adjusting signals associated with available services to shift demand. For instance, existing methods provide for real-time batching of a few service instances, however due to computing constraints associated with real-time batching there is a limit to the amount of energy which can be saved by performing these service instances in parallel. Thus, the technology of the present disclosure allows for a network computing system to shape the timing of interactions and messaging from its client devices, such that it can batch the underlying software services and associated processes that coordinate the delivery services.

By way of example, shifting or shaping demand can include determining a batch delivery window with a number of associated service instances. By increasing the quantity of service instances associated with the batch delivery window, utilization of computing and physical resources can be reduced. The present disclosure can provide for determining characteristics associated with device identifiers (e.g., users) and related incentives which can help batch computing resources utilized for coordinating delivery services. This can include, for example, intelligently interacting between network and client devices to shift demand from initiating services outside of the batch delivery window to services within the batch delivery window. For instance, a device identifier associated with service instances from a restaurant between 6:30 and 7:00 pm on a Friday can be persuaded to adjust the scheduled delivery time to a 7:00-7:30 pm or 6:00-6:30 pm window based on an offered incentive. As such, the system can determine incentives to provide for different device identifier characteristics to increase density of demand along known or expected batched routes, thereby allowing for more predictable, batched computing resources.

The incentives along with other relevant data can serve as signals which can be adjusted by processing logic to attempt to increase incremental orders during particular time windows along specific routes within which the system can increase density. In some instances, processing logic can determine an elasticity associated with a number of users. The elasticity can be indicative of a probability that the user can be persuaded to order from a particular merchant or at a particular time based on an incentive offered (e.g., based on adjusted signals).

The system can provide selectable user interface components (e.g., within a service application) which upon selection, can automatically update the user interface to display an initiated service instance associated with a batch delivery window. In some instances, the system can provide for the nudge within the application during a live device identifier session with the application. Additionally, or alternatively, the system can provide for a push notification which can, upon receipt of data indicative of a device identifier selecting the notification, launch the application with one or more suggested restaurants or additional details relating to the incentive personalized to the device identifier.

The present disclosure provides for many technical effects and benefits. For instance, the present disclosure provides for systems and methods which reduce carbon emissions associated with facilitating service instances by generating demand to increase density along routes which can provide for batching of five or more service instances by a single courier. By creating density along delivery routes and times, resources such as gas, electricity, etc. can be conserved. This can help reduce environmental costs of each respective trip by determining when service instances are likely to be placed and providing incentives to shift demand to concentrate service instances to particular times to allow for larger numbers of service instances to be batched while satisfying requirements for food safety and freshness. Additionally, in some instances, the present disclosure can provide for improved, real-time matching by determining better times for dispatching batched services instances to couriers as well as determining when a service instance should not be batched.

While methods exist for batching delivery service instances associated with nonperishable items, these methods fail to address issues that arise with real-time food delivery service instances. For instance, routes must be batched offline which takes into account predicted demand for future times which can have effects on estimated time of arrival between waypoints (e.g., due to traffic) and estimated preparation time for items associated with a service instance (e.g., based on quantity or complication of service instances at a service provider). The present disclosure addresses these needs by providing an improved system for demand shaping to determine which device identifiers (e.g., and associated users) to nudge based on preferences of the device identifier as well as known and anticipated demand to allow for improved batched service instances. System computing efficiency can be improved by determining and offering incentive to increase earlier placed orders to allow for larger batched routes to be computed and performed.

By batching a larger number of service instances using offline pre-batching, the present methods can reduce real-time computing and processing resources used by online systems. Additionally, the present disclosure provides for physical improvements and environmental savings. This can help reduce carbon emissions by 30%, by batching larger numbers of service instances based on more concentrated demand. The present disclosure additionally provides for improved utilization of computing resources by performing intelligent enumeration of batched service instances to generate potential batches and prune the service instances to provide for generation of optimized routes without wasting resources ranking routes which will later violate constraints of the system.

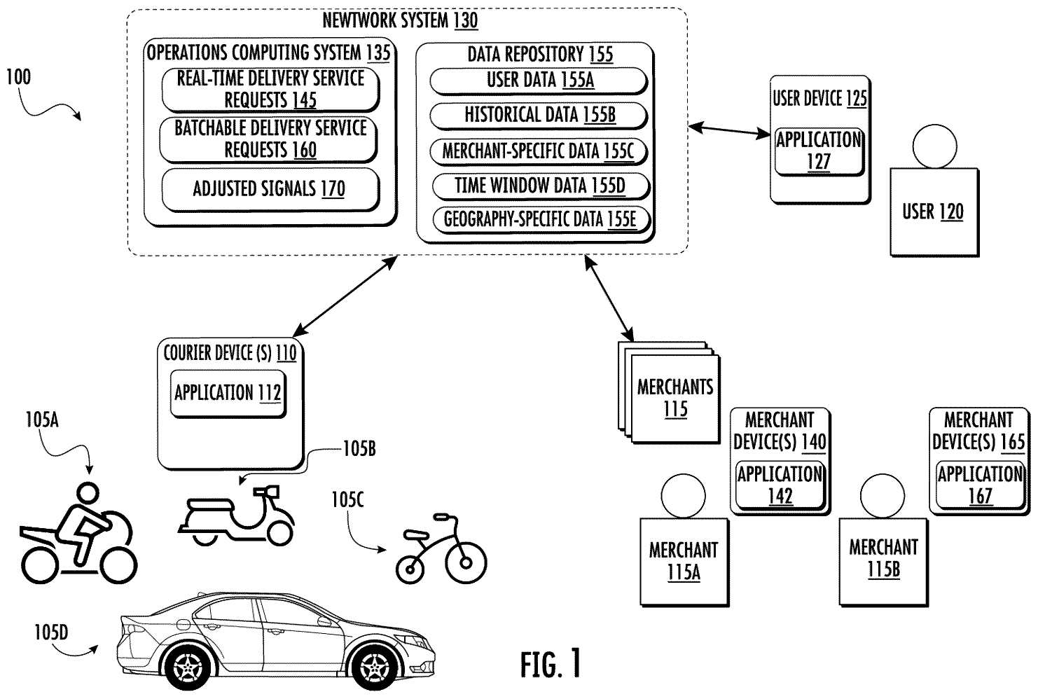

FIG. 1 depicts a block diagram of an example system 100 according to aspects of the present disclosure. As illustrated, FIG. 1 shows a system 100 that can include one or more vehicles 105A-D (e.g., a car, scooter, motorcycle, bicycle) and one or more courier devices 110 that can be associated with one or more couriers which can operate the one or more vehicles 105A-D. In some examples, the one or more couriers are humans. In some examples, the courier(s) can be non-human (e.g., vehicle, autonomous vehicle, autonomous robot).

The one or more couriers and the one or more courier devices 110 (e.g., an onboard tablet, a mobile device of a courier) can be associated with the one or more vehicles 105A-D. The courier device(s) 110 can include a software application 112 associated with a delivery service entity, which can run on the courier device(s) 110.

The system 100 can include one or more merchants 115. The merchants 115 can receive data indicative of a delivery service request from a user 120. For example, the user 120 can submit a request through a user device 125 associated with the user (e.g., via a software application 127).

A network system 130 can include a computing system associated with a service entity that can facilitate a request for services from the user 120. An operations computing system 135 associated with the delivery service entity can facilitate a request for services from the user 120.

For example, the user 120 can submit a delivery request through a user device 125 associated with the user 120 (e.g., via a software application 127). Operations computing system 135 can receive delivery service requests for a number of delivery services from a user device 125. The number delivery services can be associated with timing information. For example, real-time delivery service requests 145 can request that the service be performed within a short period of time after transmittal of the real-time delivery service request. This can include the performance of a real-time delivery service within a threshold time from submission of the real-time delivery service requests 145 to the network system 130 or another device.

Batchable delivery service requests 160 can request the performance of a delivery service within a future time range of the batchable delivery service requests 160. In some implementations, the real-time delivery service requests 145 can be for perishable items and the batchable delivery service requests 160 can be for non-perishable items. In some implementations, the batchable delivery service requests 160 can be for perishable items.

In some instances, the operations computing system 135 can determine adjusted signals 170 which can be transmitted over a network to a user device 125. The adjusted signals 170 can be transmitted to encourage user 120 to place a batchable delivery service request during a discrete time window. In some instances, adjusted signals 170 can differ for different users and user devices. For instance, adjusted signals can attempt to increase the concentration of batchable delivery service requests 160 associated with discrete time windows such that more predictable and efficient utilization of computing resources can be achieved. The more predictable and efficient utilization of computing resources can be accomplished utilizing demand shaping by determining personalized incentives for users, such as user 120, so that there will be an increase in batchable delivery service requests 160 to align with known or predicted concentrations of batchable delivery service requests 160.

The operations computing system 135 can send data indicative of a delivery service request to a merchant device 140 associated with a merchant 115A (e.g., via a software application 142). The operations computing system 135 can receive data indicative of a merchant 115A accepting the delivery service request. The operations computing system can send a request to a courier device 110 associated with the courier to complete the delivery service request (e.g., via application 112).

The network system 130 can include a data repository 155. The data repository 155 can include user data 155A (e.g., data associated with user 120), historical data 155B (e.g., data associated with user 120, data associated with merchant(s) 115, data associated with couriers), merchant-specific data 155C (e.g., real-time data associated with merchants 115), time window data 155D (e.g., current scheduled orders within a time window, expected scheduled orders to be placed for a time window), geography-specific data 155E (e.g., current scheduled orders for a particular geographic region or subregion, expected scheduled orders to be placed for a particular geographic region or subregion), or any other relevant data (e.g., system-level data associated with a number of users, expected demand).

The operations computing system 135 can generate data indicative of the delivery service requests and can provide data for display on a user device 125 (e.g., via application 127) indicative of updates on the delivery service request, recommended actions for the user to take, or incentives for scheduling an order for discrete time windows. For example, an update can include an update about what stage of delivery the delivery service is in (e.g., preparation, pick-up by courier, courier in route, approaching delivery, delivered).

The operations computing system 135 associated with the service entity can receive a delivery service request from the user device 125. The operations computing system 135 can send a request to a courier device 110 associated with a courier (e.g., via a software application 112) for the courier to perform the requested primary order request service. The courier can be associated with the vehicle (e.g., vehicle 105A-D).

The operations computing system 135 can generate adjusted signals 170 to transmit to a user device to shape demand for discrete time windows. The operations computing system 135 can generate batched delivery service requests including a number of pick-up locations, drop-off locations, and items associated with the service request.

The operations computing system 135 can communicate data indicative of the delivery service request to a courier (e.g., a human courier, an autonomous vehicle courier, an autonomous robot courier). For instance, the operations computing system 135 can send a request to the courier device 110 of the courier. Additionally, or alternatively, the operations computing system 135 can send a request to a courier device(s) 110 (e.g., a tablet stored onboard the vehicle) of at least one of vehicles 105A-D. The request can be communicated to the courier via the software application 112 running on the courier device 110 associated with the courier.

A courier can provide user input to the courier device 110 (e.g., via the software application 112) to accept or decline the vehicle service request. In some examples, user input can be provided directly into a service application (e.g., via a user interface element). Additionally, or alternatively, user input can be provided via an application programing interface (API) or a third-party application. Data indicative of the acceptance or rejection of the request can be provided to the operations computing system 135.

The systems of FIG. 1 can create a hybrid approach for scheduling delivery services that seamlessly integrates real-time courier matching with pre-matching batch analysis to optimize courier time.

The systems of FIG. 1 can provide for batching computing resources for discrete time windows to allow for more predictable and efficient utilization of computing resources. For instance, the systems of FIG. 1 can shape demand by determining incentives for users to be transmitted to increase the number of orders for discrete time windows. For instance, more efficient batches can be generated where travel segments of routes between pick-up location and drop-off locations overlap during high-demand time windows (e.g., such as dinner time, lunch time). By concentrating the larger number of batched service instances within these discrete time windows, this can allow for decreasing an average delivery time per trip even though a number of batched orders is larger. This allows for computing efficiencies by transmitting less service requests to be accepted or rejected by couriers as well as contributing to sustainability goals by decreasing greenhouse gas emissions. Further, because real-time matching does not allow for enough time to batch the larger number of service instances, the present disclosure provides for shaping when this data is gathered (e.g., far enough in advance of the compute time) such that the demand can be shaped around the desired time windows.

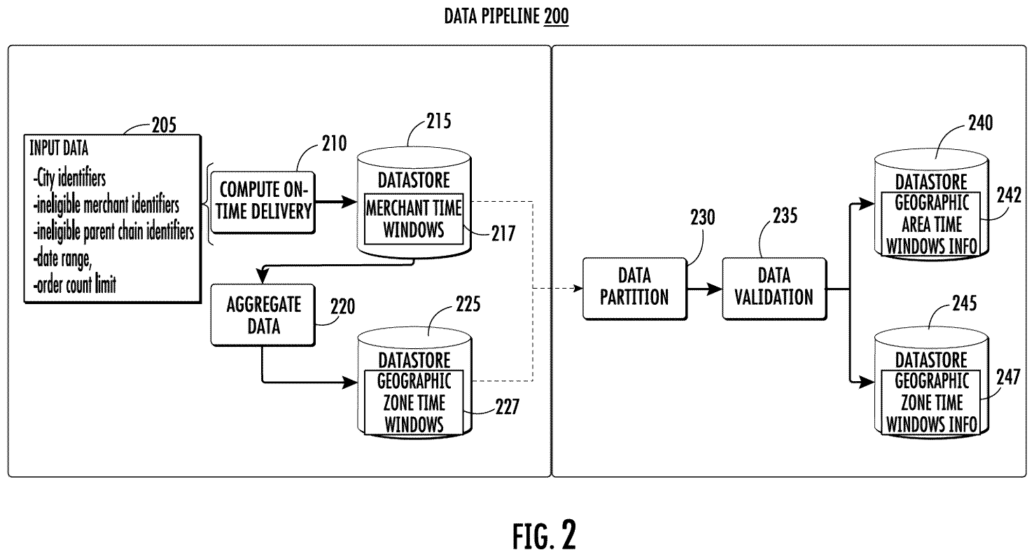

This demand shaping can be performed utilizing various systems and methods including those of data pipeline 200 depicted in FIG. 2. FIG. 2 depicts an example data pipeline 200 for adjusting signals to shift resource utilization (e.g., perform demand shaping) according to embodiments described herein. The data pipeline 200 can provide for a scalable low-latency solution to allow for identification of eligible merchants and time windows given a delivery location associated with the service request. For instance, given a delivery location, such as a current location associated with a user device, the system can return a list including a number of merchants and associated time windows or incentives. Additionally, or alternatively, within a store front or checkout interface associated with the service application, given a selected merchant data and user device data, the system can provide a number of eligible time windows and incentives.

For instance, data pipeline 200 can include compute on-time delivery component 210 which can obtain input data 205 to generate merchant time windows 217 as output. Input data 205 can include city identifiers, ineligible merchant identifiers, ineligible parent chain identifiers, date range, order count limit, or other relevant data. City identifiers can include an identifier associated with a discrete geographic region. In some instances, a geographic region can include a city, state, town, or other discrete geographic unit. Ineligible merchant identifiers and ineligible parent chain identifiers can include merchants or parent chains of merchants that have opted out or are otherwise ineligible for batched assignments (or batched assignments over a certain number of service instances). For instance, due to restrictions related to food safety or time in transit, certain merchants can be excluded from being included in the demand shaping batches. A date range can include a number of days which are eligible for scheduling orders. An order count limit can include a cap on the number of orders which can be batched in addition to a particular order or within a discrete time window. In some instances, input data 205 can include additional relevant data for computing on-time delivery.

The merchant time windows 217 can be stored in datastore 215. For instance, merchant time windows 217 can include data associated with time windows with associated existing service requests for specific merchants.

Aggregate data component 220 can obtain data from datastore 215 to generate aggregated data which can be stored in datastore 225. For instance, aggregate data component 220 can group merchants within the same geographic zones within the discrete time windows to generate geographic zone time windows 227.

The data stored in datastore 225 can include geographic zone time windows 227. Geographic zone time windows 227 can include data associated with certain pick-up or drop-off locations and associated time windows. In some instances, the locations can include geozones, hexes, streets, or other units of geographic measurement.

Data partition component 230 can obtain data from datastore 215 and datastore 225 and provide smaller portions of data to be processed for data validation 235. By way of example, the data can be partitioned based on time window, pick-up or drop-off location, number of existing service instances for the location or time window, order size, or other relevant data. For instance, data partition component 230 can determine which portions of data from datastore 215 and datastore 225 should be utilized to generate recommendations as output. In some instances, generating recommendations as output can include performing pruning of undesirable routes, cities, or other geographic units of measure. Data validation 235 can include confirming that the restaurant is open, that items associated with the service instance are in-stock, confirming that the time window can be associated with the incentive. Additionally, data validation can determine time windows which could benefit from additional orders or particular segments of routes that could benefit from additional orders during discrete time windows and over discrete geographical locations for pick-up and drop-off. By partitioning the data, processing of the partitions of data can be performed in parallel to help reduce computing process time. Additionally, or alternatively, by partitioning the data, certain partitions of data can be held back or otherwise not processed to prevent unnecessary computing resource utilization.

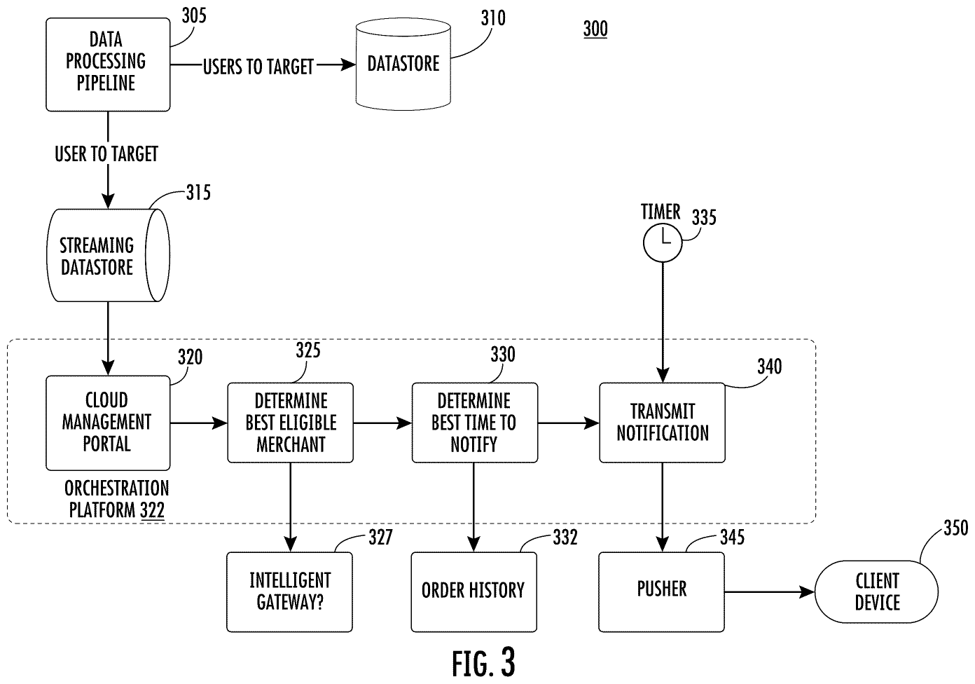

Output of data validation 235 can be stored in datastore 240 and datastore 245. For instance, datastore 240 can store data associated with larger units of geographic measurement, such as a city or town. For instance, datastore 240 can store geographic area time windows information 242. Datastore 245 can store data associated with smaller units of geographic measurement such as hexes, geozones, or other subunits. The data generated through data pipeline 200 can be utilized to determine when to generate offers for a user. Offers can include nudges such as push notifications, incentives within a service application interface, or other tools utilized to increase a probability that a user places an order ahead of time for a discrete time window. For instance, data pipeline 200 can be associated with data processing pipeline 305 described in FIG. 3.

FIG. 3 depicts an example data pipeline 300. Data pipeline 300 can include data processing pipeline 305. As described herein, in some example implementations, data processing pipeline 305 can include data pipeline 200. Data can be processed by data processing pipeline 305. The output of the data processing pipeline 305 can include data which can be stored in datastore 310 or streaming datastore 315.

Streaming datastore 315 can include a streaming function and a storage function. For instance, streaming datastore 315 can pull or otherwise request data from a number of devices or from a centralized data source (e.g., datastore 240 or datastore 245). The data obtained can be processed by streaming datastore 315 and stored until the data is needed or requested (e.g., by cloud management portal 320).

For instance, streaming datastore 315 can retrieve eligible time windows and merchant information at a city level. By way of example, streamlining datastore 315 can read city level partition data from geographic zones time windows info 247 from datastore 245 to fetch (store geographic zone, time window) level data. Time windows that are too close to the current time (e.g., within an hour or some other determined amount of time), can be removed. Based on a drop-off location (e.g., current location of user device), geographic zone location, and maximum delivery radius, geographic zones without eligible merchants can be removed or otherwise filtered out. In some implementations, geographic zones can be filtered out based on a pick-up location to drop-off location direction vector which can be limited to certain directions. Any non-filtered time windows and merchant information can be returned and can be sorted based on the discrete time windows.

Cloud management portal 320 can request data and obtain the data from streaming datastore 315 to perform various operations via orchestration platform 322. Orchestration platform 322 can include a number of operations. The operations can include, for example, determining best eligible merchant 325. The best eligible merchant 325 can include, for example, a merchant selected based on rating, location, experience match, existing orders placed for a scheduled time, expected orders to be placed for a scheduled time, or other relevant factors. Based on data available to orchestration platform 322, the system can determine a best eligible merchant 325. In some instances, the system can provide the eligible merchants for display via a client device. For instance, the system can determine if the device is associated with an intelligent gateway 327.

Orchestration platform 322 can include determining a best time to notify 330. For instance, based on order history 332, number of items in an order, restaurant history data, or other relevant data, the orchestration platform 322 can determine the best time to transmit a notification associated with an offer for ordering from specified restaurants within a discrete time window. As such, this data can be utilized by orchestration platform 322 to determine the best time to notify 330.

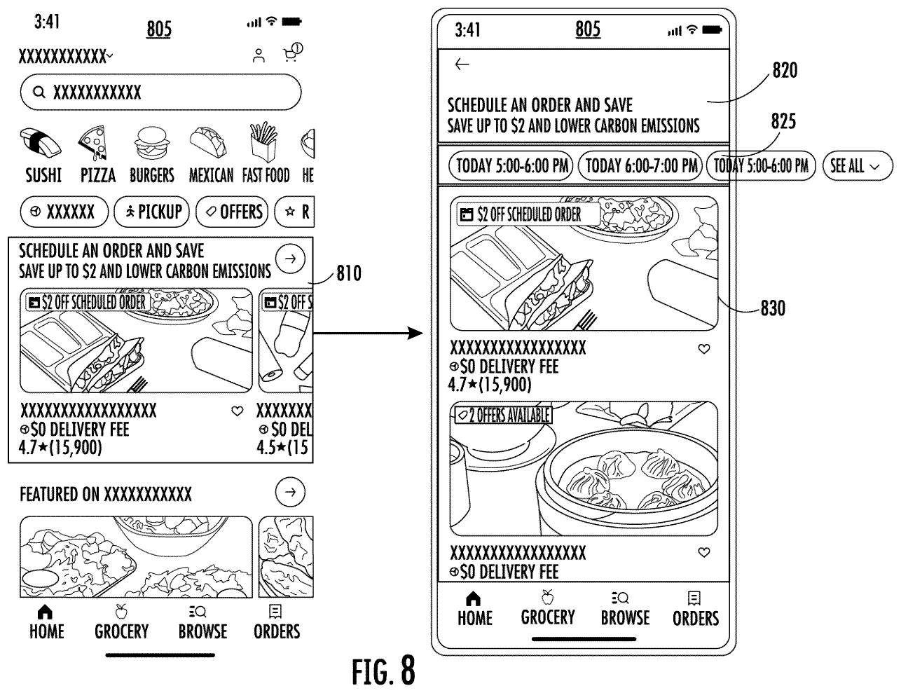

Orchestration platform 322 can include transmitting a notification 340 based on the determined best eligible merchant 325, determined best time to notify, and timer 335. In some instances, a notification can be transmitted to a publisher 345. The publisher 345 can provide the notification for display via client device 350. For instance, the notification can include a push notification, an indication of a discount within an application, updating a user interface associated with a service application to include a schedule and save component, or any other relevant form of notification. Some examples of graphical user interfaces associated with notifications are described in FIGS. 8 to 10.

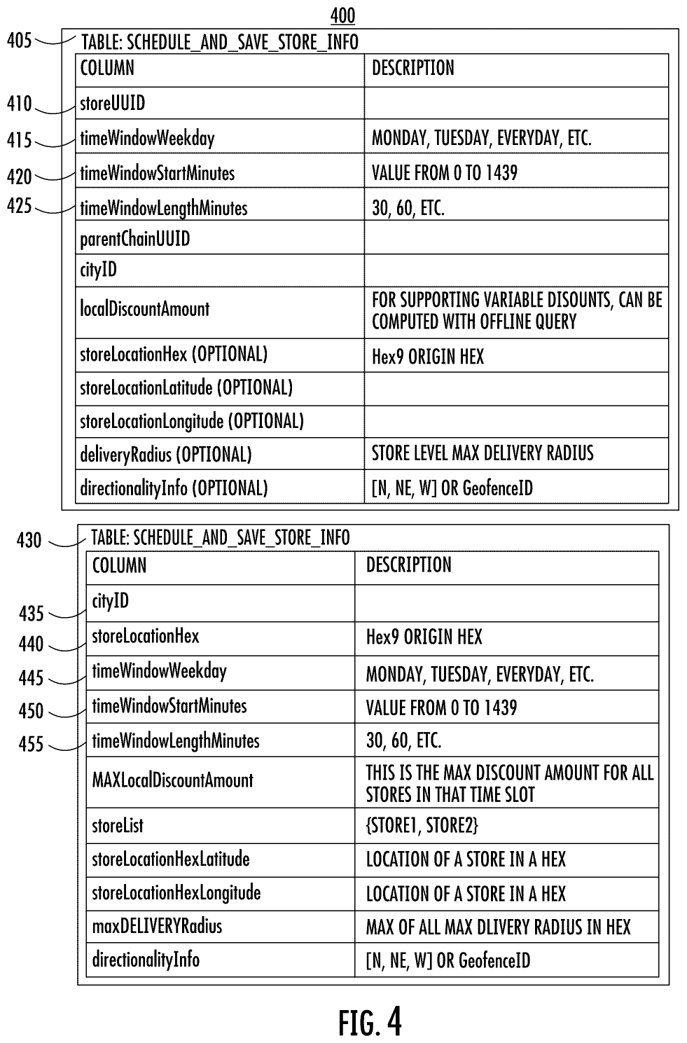

The present disclosure provides for improved processing of data to allow for batching computing resource utilization within discrete time windows. This is performed by the orchestration of various data stores and data processing pipelines such as those described in FIGS. 2 and 4. FIG. 4 depicts example data structure 400 according to embodiments of the present disclosure. For instance, data structure 400 can include a schedule and save store info table 405 (e.g., datastore 215) and schedule and save city hex info table 430 (e.g., datastore 225).

The two respective tables can include column data and description data. Schedule and save store info table 405 can include a number of data entries. For instance, data entries can include store unique identifier 410, time window weekday 415, time window start 420, time or time window length 425. Each column can have associated description data. For instance, time window weekday 415 can be associated with days of the week, time window start 420 can be associated with a value from 0 to 1439. Time window length 425 can be associated with a length of time such as 30 minutes or 60 minutes for a delivery window.

Additional column data examples can include a parent chain identifier, a city identifier, a local discount amount (e.g., to support variable incentives or discounts which can be computed with an offline query), a store location (e.g., hex location, latitude, longitude), a delivery radius (e.g., store level max delivery radius), or directionality information (e.g., N, NE, E, SE, S, SW, W, NW, or geofence identifier).

Schedule and save city hex info table 430 can include column data and description data. Data entries for the column can include a city identifier 435, a store location hex 440, a time window weekday 445 (e.g., Monday, Tuesday, Everyday), time window starts 450 (e.g., value from 0 to 1439), or time window length minutes 455 (e.g., 30, 60, etc.). Additionally, or alternatively, the data structures can include a max local discount amount (e.g., a maximum discount amount for merchants associated with a time window), a store list (e.g., a listing of available merchants associated with potential incentives or discounts), a store location hex latitude, a store location hex longitude, a max delivery radius (e.g., a maximum radius of all maximum delivery radii within a hex), or directionality information (e.g., N, NE, E, SE, S, SW, W, NW, or geofence identifier).

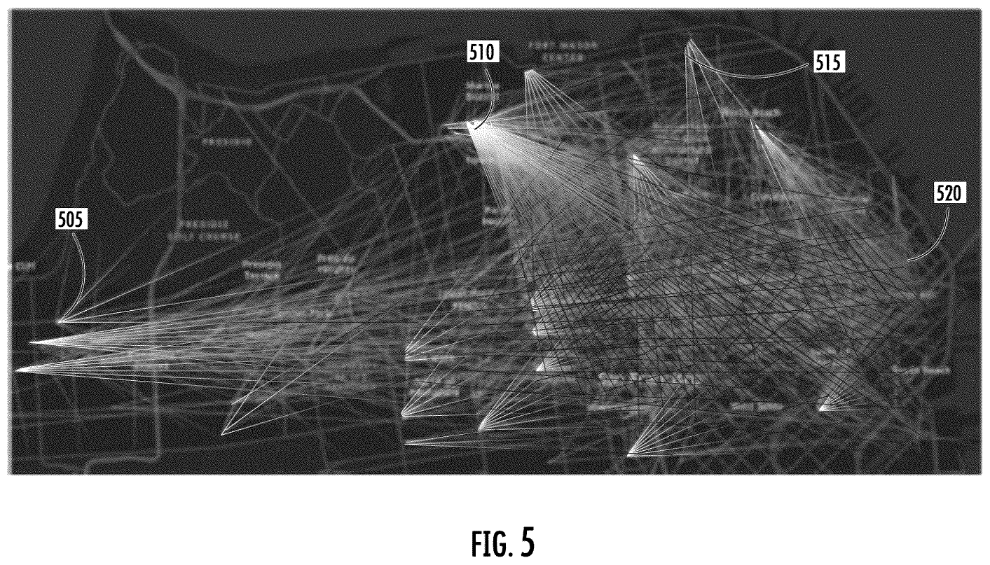

FIG. 5 depicts an example map of orders that are directionally left to right (e.g., with pick-up locations being to the left of drop-off locations for the respective service instances) within a geographic area on a single evening over a 3-hour period of time. The graphic shows much overlapping traffic associated with pick-up and drop-off locations. For instance, the pick-up locations can include pick-up location 505, pick-up location 510, and pick-up location 515. The drop-off locations which can include drop-off location 520. As can be visualized, there is a large amount of overlapping routes between pick-up and drop-off locations within the geographic area. As such, efficiencies can be obtained by shaping the demand within the geographic regions to allow for optimization of the computing resource utilization within the geographic area during the discrete time windows. This can include reducing a number of real-time requests which must be processed as well as reducing the number of service requests which are transmitted to courier devices due to consolidation of the service requests into batches. When performed at scale, this can provide for great reduction in the amount of data transmission and bandwidth utilization which can provide for reduced latency and increased processing speeds for other computing needs of the distributed system.

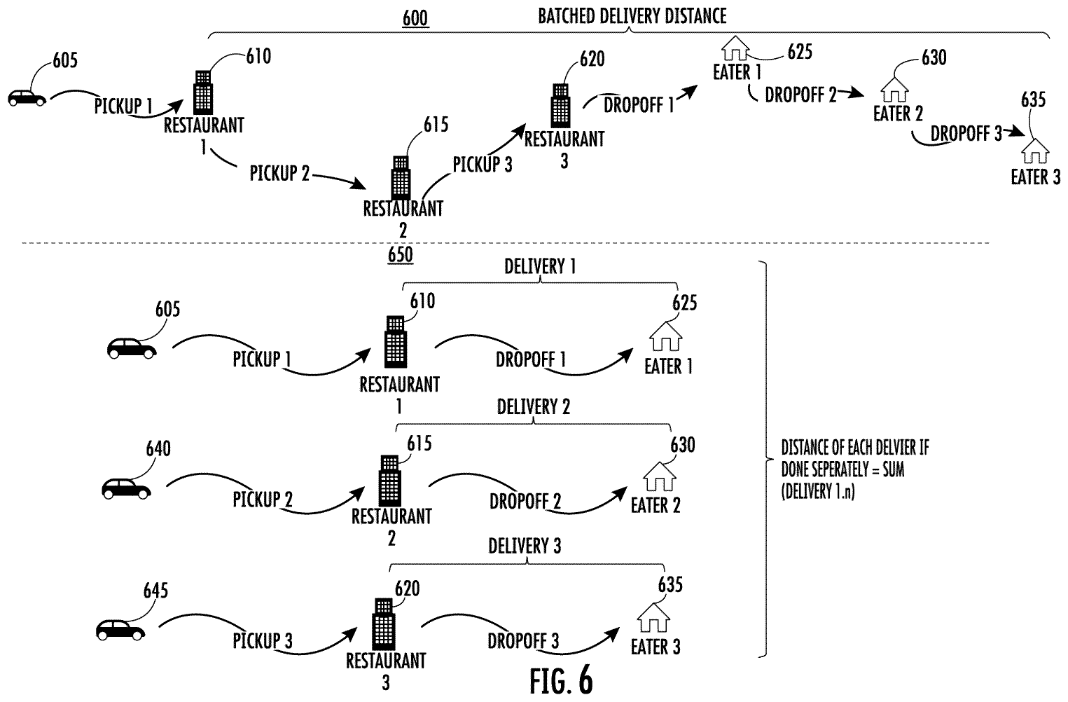

FIG. 6 depicts an example illustration of a batched order with a number of pick-up and drop-off locations as compared to traditional methods which require a distinct courier to perform each individual service instance. For instance, in the batched scenario 600, a first courier 605 can pick up items at a first merchant 610, and second merchant 615, and a third merchant location 620. The items picked up at the various merchants can be associated with a number of different service instances. The service instances can be associated with a number of drop-off locations including drop-off location 625, drop-off location 630, and drop-off location 635.

This provides for a number of efficiencies by reducing the carbon footprint of providing services and reducing the bandwidth and network utilization due to a decrease in communication transmitted between the network system and courier devices. For instance, instead of requests for three distinct requests being transmitted, a single request for the three service instances can be transmitted. When this is performed at scale, a measurable reduction of bandwidth utilization can be observed.

Traditional methods, such as those depicted in traditional scenario 650, would require a first courier 605 to transport an item for pick-up from merchant 1 610 to drop-off location 1 625. A second courier 640 can transport an item for pick-up from merchant 2 615 to drop-off location 630. A third courier 645 can transport an item for pick-up to a third merchant location 620 for drop-off at drop-off location 635. As described herein, the batched scenario 600 provides for numerous benefits over the traditional scenario 650.

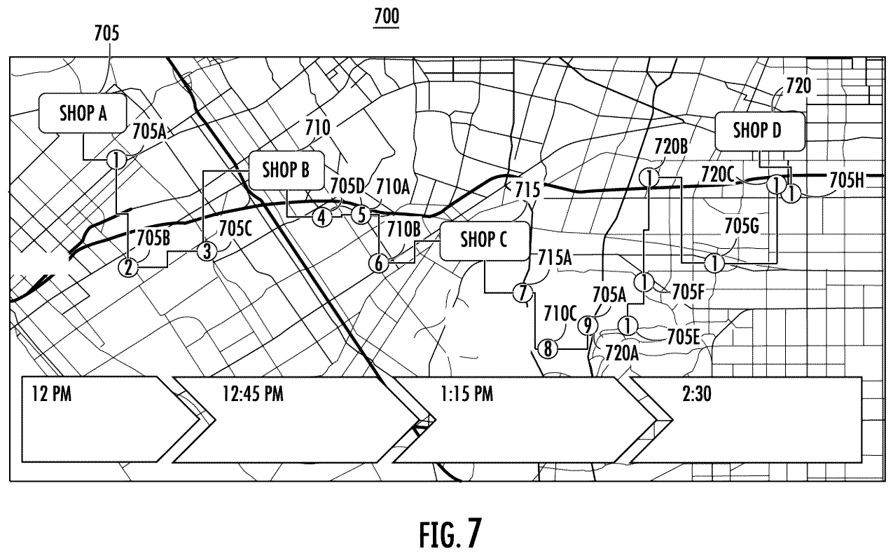

FIG. 7 depicts an additional example of batching performed for a number of merchants and orders associated with the respective merchants. For instance, as depicted, batched assignment 700 can include 14 service instances associated with four merchants. Merchants can include restaurants, retail stores, shipping distribution facilities, freight distribution facilities (e.g., for facilitating last mile delivery), post offices, or other mailing facilities.

By way of example, shop A 705 can be associated with drop-off location 705A, drop-off location 705B, drop-off location 705C, drop-off location 705D, drop-off location 705E, drop-off location 705F, drop-off location 705G, and drop-off location 705H. Service instances associated with drop-off locations 705A-C can be performed before a pick-up is performed at shop B 710. The service instance associated with drop-off location 705D can be completed after the pick-up at shop B 710 has occurred. Due to the nature of the service instances and goods associated with shop A 705 and drop-off locations 705A-H, these service instances can be completed across the entire batched assignment.

Shop B 710 can be associated with service instances with drop-off location 710A, drop-off location 710B, and drop-off location 710C. As depicted in batched assignment 700, two of the services instances (e.g., associated with drop-off location 710A and drop-off location 710B) can be performed before the pick-up at shop C 715 and one of the services instances (e.g., associated with drop-off location 710C) can be performed following the pick-up from shop C 715 and drop-off location 715A.

Shop C 715 can be associated with a single service instance associated with drop-off location 715A. For instance, shop C 715 can be associated with a restriction on the amount of time a food item can be within a delivery vehicle or some other physical restriction that prevents an interceding service instance drop-off or pick-up to occur. However, due to the time requirements of the other service instances depicted in batched assignment 700, and the geography covered, the system can batch all of the assignments together to reduce transmission of requests to multiple couriers to perform the service instances. Additionally, the system can pre-plan portions of the batched assignment 700, while others can be added in a more real-time fashion. For instance, based on the existing route associated with the services instances associated with shop A 705, shop B 710, and shop D 720, the system can determine that the service instance drop-off location 715A with the pick-up location at shop C 715 can and should be batched with the other service instances.

Shop D 720 can be associated with pick-up location 720A, pick-up location 720B, and pick-up location 720C. For instance, the pick-up locations associated with shop D 720 can be for service instances associated with returning or shipping a package, returning an item to a merchant, or some other service instance where an item would be picked up from a location associated with a service instance and dropped off at a merchant (e.g., opposed to being picked up at the merchant).

The benefits of performing the batching of numerous service instances provide for computing efficiencies with regard to the data transmission that occurs for transmitting requests and acceptance of service assignments to couriers. Additionally, it provides for environmental savings by reducing carbon emissions by more intelligently routing. This can be understood by comparing the batched versus individual trips depicted in FIG. 6 and extrapolating the savings when looking at a batched assignment such as batched assignment 700 depicted in FIG. 7.

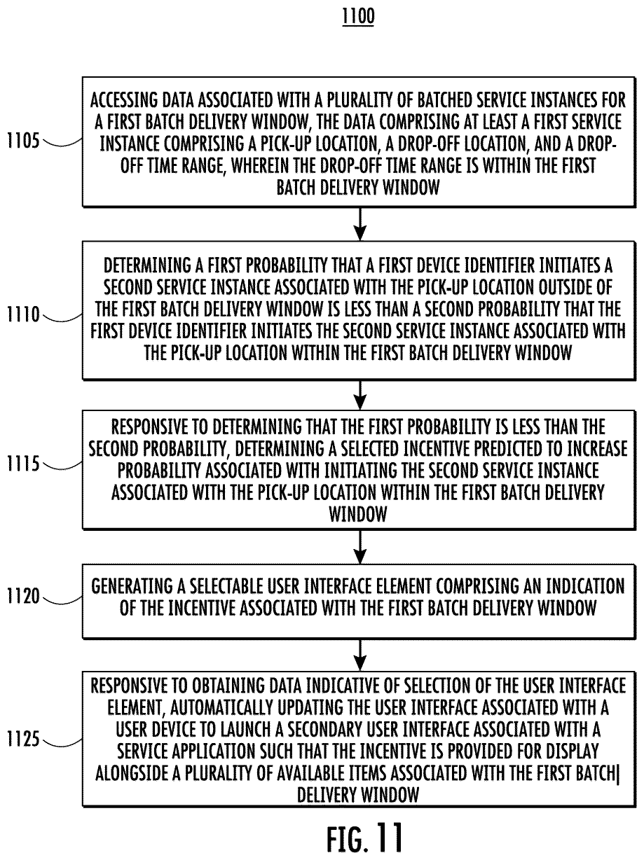

FIG. 8 depicts example graphical user interface 805 and graphical user interface 815. Graphical user interface 805 can depict a user interface associated with a service provider. The user interfaces can be personalized based on data associated with a user, time of day, location, available couriers, or other relevant information (e.g., as described with regard to FIG. 11). Graphical user interface 805 can include a schedule an order and save clement 810. The schedule an order and save clement 810 can be personalized based on incentives customized to a device or user identifier. The personalization and incentives to provide for display via schedule an order and save element 810 can be determined by the system based on existing service instances for specific times, drop-off location associated with the device identifier, pick-up location associated with various candidate merchants, preferences associated with the device or user identifier, or other relevant inputs. The system can provide schedule an order and save element 810 to shape the demand for particular times to provide for optimization of resource utilization such as compute resource optimization by reducing the number of individual service requests or assignments which need to be processed or batched in real-time as well as reducing carbon emissions by batching items which will help reduce unnecessary overlap in routes if performed by multiple couriers.

Schedule an order and save element 810 can be expanded to render as depicted by graphical user interface 815. Graphical user interface 815 can include header 820, time windows 825, and merchants 830. For instance, header 820 can include additional information relating to the incentives which can be provided by scheduling. For instance, incentives can include a discount, such as $2 off, an indication of the predicted carbon emissions saved, a percentage off an order, rewards points or currency, or any other incentive. The incentive can be personalized based on user preferences or past behavior, or time windows or merchants which would result in increased compute resource and carbon emissions savings (e.g., due to existing orders which could be batched, expected orders to be batched).

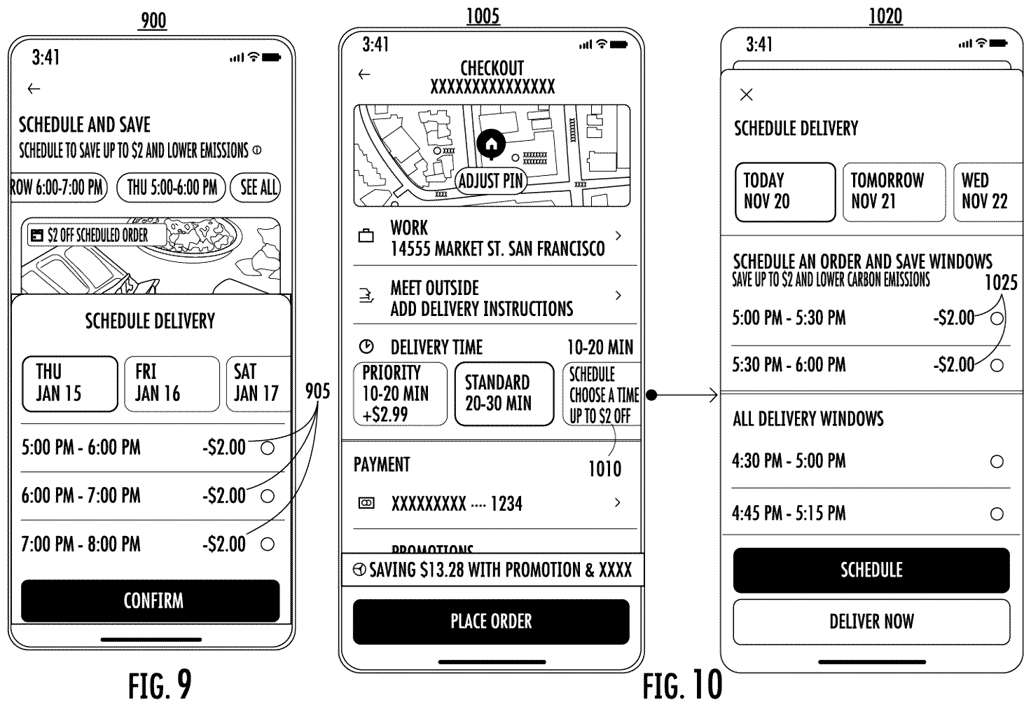

FIG. 9 depicts an example graphical user interface 900 which can be provided for display after a user has selected a merchant or completed adding items to a cart. Graphical user interface 900 can include incentive indicators 905. Incentive indicators can vary based on time window or other relevant factors.

FIG. 10 depicts example graphical user interface 1005 and graphical user interface 1020. Graphical user interface 1005 depicts an example checkout interface associated with placing an order and initiating a service instance. Graphical user interface 1005 can include a schedule clement 1010. Schedule element 1010 can be selected to receive an incentive and select a time to schedule the order. For instance, upon selection of schedule element 1010, graphical user interface 1005 can be automatically updated to render as graphical user interface 1020. Graphical user interface 1020 can include a selection for date, schedule and save delivery windows with incentive indicators 1025, and all delivery windows which do not have an incentive indicator. The methods described herein can be used to determine when to provide for an incentive or otherwise qualify a time or merchant for a schedule and save (e.g., batched) assignment. Additionally, the methods described herein, for instance with regard to FIG. 11, can be utilized to determine when to provide these incentives.

FIG. 11 depicts a flowchart diagram of an example method 1100 to perform demand shaping by adjusting signals to shift system resource utilization in accordance with some embodiments of the present disclosure. Method 1100 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 1100 can be performed by network computing system (e.g., network system 130, service entity computing system 1505) which can be a distributed computing system (e.g., cloud-based systems). FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 1105, processing logic can access data associated with a number of batched service instances for a first batch delivery window. The data can include at least a first service instance including a pick-up location, a drop-off location, and a drop-off time range. The drop-off time range is within the first batch delivery window. For instance, a first batch delivery window can be a time window associated with a duration of time, such as 30 minutes or one hour.

By way of example, a first batch delivery window can include a time window from 6:00-6:30 pm on a Friday evening.

At operation 1110, processing logic can determine a first probability that a first device identifier initiates a second service instance associated with the pick-up location outside of the first batch delivery window is greater than a second probability that the first device identifier initiates the second service instance associated with the pick-up location within the first batch delivery window.

Turning back to the example, the first probability can be indicative of the likelihood that a user (e.g., associated with a first device identifier) initiates a service request associated with a same pick-up location during a time window outside of the 6:00-6:30 pm on a Friday evening time window. For instance, a user can regularly place a real-time order or place a scheduled order between 5:15-5:45 pm on a Friday evening. As such, it is more likely that the user will place an order between 5:15-5:45 pm as compared to between 6:00-6:30 pm.

At operation 1115, processing logic can determine a selected incentive predicted to increase probability associated with initiating the second service instance associated with the pick-up location within the first batch delivery window in response to determining that the first probability is less than the second probability. The incentives can include at least one of: (i) a discount, (ii) a reward, or (iii) a metric of an amount of carbon dioxide usage reduced by selecting a drop-off time within the first batch delivery window. For instance, a discount can include a dollar or percentage taken off a present order. A reward can be associated with an in-service-application currency or point system. The metric of the amount of carbon dioxide usage reduced can be determined based on predicted batching options or based on existing scheduled orders which can be batched together during the first batch delivery window.

Processing logic can determine a metric of an amount of carbon dioxide usage reduced. For instance, processing logic can sum a distance of each service instance of the number of service instances in the batch route. Processing logic can determine a difference by subtracting a batched delivery distance including a sum of the distances between each waypoint of the batched delivery from the sum of the distance of each service instance. Processing logic can divide the difference by a number of individual service instances. Processing logic can multiply the distance saved by a known carbon dioxide footprint value associated with a unit of distance.

In some instances, the incentive can be tailored to a particular user or device identifier. For instance, the selected incentive can be determined based on device identifier profile data. As such, processing logic can determine the selected incentive predicted to increase probability associated with initiating the second service instance associated with the pick-up location within the first batch delivery window. For instance, processing logic can determine a number of candidate incentives. Processing logic can determine that a first incentive of the number of candidate incentives causes a probability adjustment including the second probability to exceed the first probability based on device identifier profile data (e.g., the incentive can be tailored based on device identifier profile data or user identifier profile data). Processing logic can select the first incentive based on the probability adjustment.

Turning back to the example, since the typical order window for the user is about 15 minutes different from the first batch window (e.g., 6:00-6:30 pm compared to 5:15-5:30 pm) a smaller incentive can be required as compared to a user who normally orders between 4:30-5:00 pm. While this example contemplates distinction in incentive based on prior history associated with placed orders, it can additionally take into account ordering from particular merchants, types of items ordered, the difference in time between placing the order and when the order will be initiated, existing orders for the first batched delivery window, or predicted orders for the first batched delivery window.

Additionally, or alternatively, an incentive that is merchant-specific can provide for a larger incentive for a merchant that a user has no order history with compared to a merchant that the user regularly orders from. As such, a larger incentive is required to attempt to shape demand such that a user will act in a way that can allow for more efficient batching and computing resource utilization (e.g., by placing an order ahead of time for a particular merchant during a particular time window). In some instances, orders can be batched with other orders with the same delivery window. However, in some instances, when a large number of orders are batched, the total trip time can be on the order of over an hour (or even multiple hours). As such, the system can intelligently generate routes that span across batch time windows such that an order (or multiple orders) associated with a first time window (e.g., 6:00-6:30 pm) can be completed and subsequently, orders associated with a second time window can be performed (E.g., 6:15-6:45 pm, 6:30-7:00 pm), and so on.

At operation 1120, processing logic can generate a selectable user interface clement including an indication of the incentive associated with the first batch delivery window. By way of example, the selectable user interface element can include a push notification provided via a home screen or other user interface outside of a service application, can include a selectable user interface component within a service application.

At operation 1125, processing logic can automatically update the user interface associated with a user device to launch a secondary user interface associated with a service application such that the incentive is provided for display alongside a number of available items associated with the first batch delivery window in response to obtaining data indicative of selection of the user interface element. For instance, the secondary user interface can include an interface for placing an order or selecting items for an order to be scheduled for delivery during the first batch delivery window.

In some instances, batching of services can additionally, or alternatively include batching larger portions of particular food items to help provide efficiencies and reduction in food waste or allow for efficiencies to be gained by a merchant producing a large volume of a food item. As such, the system can additionally determine items eligible for being prepared in large quantities and provide for merchant and item specific recommendations to demand shift on the items that are selected by a user.

As such, the method described herein can provide for demand shifting by determining a time in which to transmit the notification such that the system provides for nudges to device identifiers such that improved offline batching of large number of service instances (e.g., more than five) can be performed.

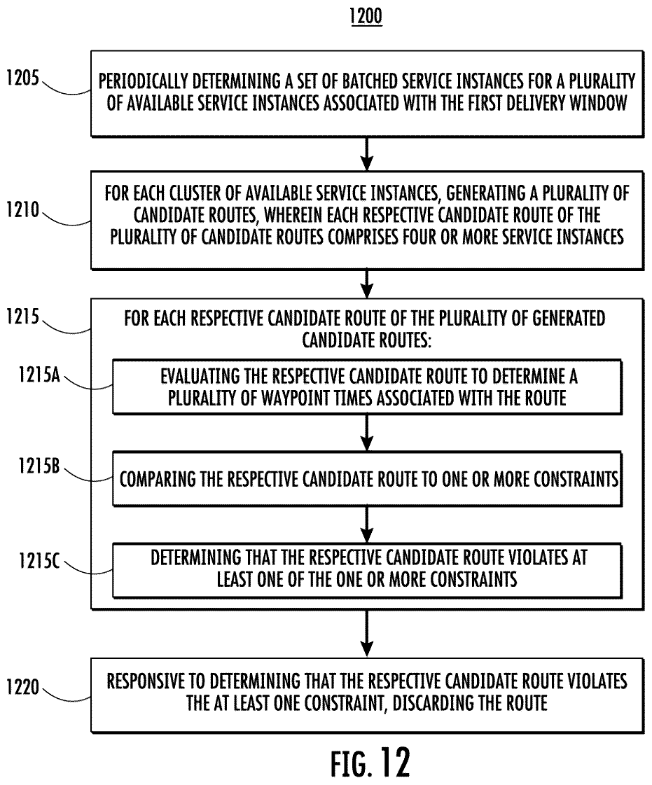

FIG. 12 depicts a flowchart diagram of an example method 1200 to perform demand shaping by adjusting signals to shift system resource utilization in accordance with some embodiments of the present disclosure. Method 1200 can be performed by processing logic that can include hardware (e.g., computing devices, processing devices, circuitry, programmable logic, dedicated logic, hardware of a device, microcode, integrated circuit, etc.), software (e.g., instructions that are executable or can run on a processing device), or a combination thereof. In some implementations, method 1200 can be performed by network computing system (e.g., network system 130, service entity computing system 1505) which can be a distributed computing system (e.g., cloud-based systems). FIG. 12 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure, and some processes can be performed in parallel. In some embodiments, one or more processes can be omitted. Thus, not all processes are required by every embodiment. Additional or alternative process flows are possible.

At operation 1205, processing logic periodically determines a set of batched service instances, or a number of available service instances associated with the first delivery window. Processing logic can determine the set of batched service instances or number of available service instances by: obtaining data associated with the number of available service instances and generating clusters of the number of available service instances into subgroups based on at least one of pick-up time, number of items, or metadata associated with the items.

At operation 1210, processing logic can, for each cluster of available service instances, generate a number of candidate routes, wherein each respective candidate route of the number of candidate routes includes four or more service instances.

By way of example, processing logic can continually generate sets of batched service instances by, for each respective service instance, determining a set number of service instances which would be most efficient to be paired. This process can be repeated for the second service instance to create the candidate clusters of service instances.

At operation 1215, processing logic can, for each respective candidate route of the number of generated candidate routes, perform operations to determine whether to remove or maintain a candidate route.

For instance, at operation 1215A, processing logic can evaluate the respective candidate route to determine a number of waypoint times associated with the route. For instance, the waypoint times can include predicted arrival, dwell, and departure time for each respective pick-up or drop-off location associated with the route.

At operation 1215B, processing logic can compare the respective candidate route to one or more constraints. The one or more constraints can include at least a time window constraint. In some implementations, processing logic can generate the time window constraint by computing an estimated time of arrival between each waypoint of the number of waypoints of the respective candidate route and for each waypoint of the number of waypoints computing an earliest timestamp and a latest timestamp. The earliest timestamp can include an earliest acceptable arrival without requiring a dwell time exceeding a threshold. The latest timestamp can include a latest acceptable arrival to allow for pick-up and arriving at the final destination within the first batch delivery window.

Processing logic can determine an estimated time of arrival for a current waypoint based on a task time associated with the current waypoint and a travel time between a previous waypoint and the current waypoint. For instance, a task time can be associated with a dwell time for a particular location. In some instances, the task time can be based on availability of parking, whether a courier must depart a vehicle, historical wait time for couriers, or other data relevant to determining a predicted task time.

At operation 1215C, processing logic can determine that the respective candidate route violates at least one of the one or more constraints. By way of example, processing logic can determine that the earliest timestamp and the latest timestamp do not satisfy a condition set including timestamp end plus the estimated time of arrival of current waypoint is greater than waypoint start timestamp and timestamp start plus the estimated time of arrival of current waypoint is less than waypoint finish timestamp. For instance, based on the calculation, either the courier will arrive too early or too late to be able to complete the respective service instances as a batched assignment.

At operation 1220, processing logic responsive to determining that the respective candidate route violates the at least one constraint, discarding the route. By way of example, Processing logic can discard the respective candidate route from the number of candidate routes responsive to determining that the earliest timestamp or the latest timestamp do not satisfy the condition set. As such, the candidate routes can be pruned.

Additionally, or alternatively, processing logic can determine that the respective candidate route does not violate any constraint and maintain the route as a candidate route. For instance, processing logic can determine that the respective candidate route satisfies the one or more constraints (e.g., satisfies the earliest timestamp and latest timestamp).

Processing logic can select a subset of routes of the number of candidate routes. Within the selected subset of routes, each service instance is associated with no more than one route. For each selected route, processing logic can determine an earliest dispatch time and a latest dispatch time for all service instances associated with the selected route based at least in part on a route dispatch time.

Processing logic can access a datastore including a number of candidate couriers and current locations of the respective candidate couriers responsive to determining that a current time is between the earliest dispatch time and the latest dispatch time. Processing logic can assign, based on the current location of a number of candidate couriers and an estimated arrival time to a first waypoint of the first service instance of the selected route, a first courier to perform the batched route. Processing logic can automatically transmit instructions which cause a device associated with the first courier to display information associated with the batched route.

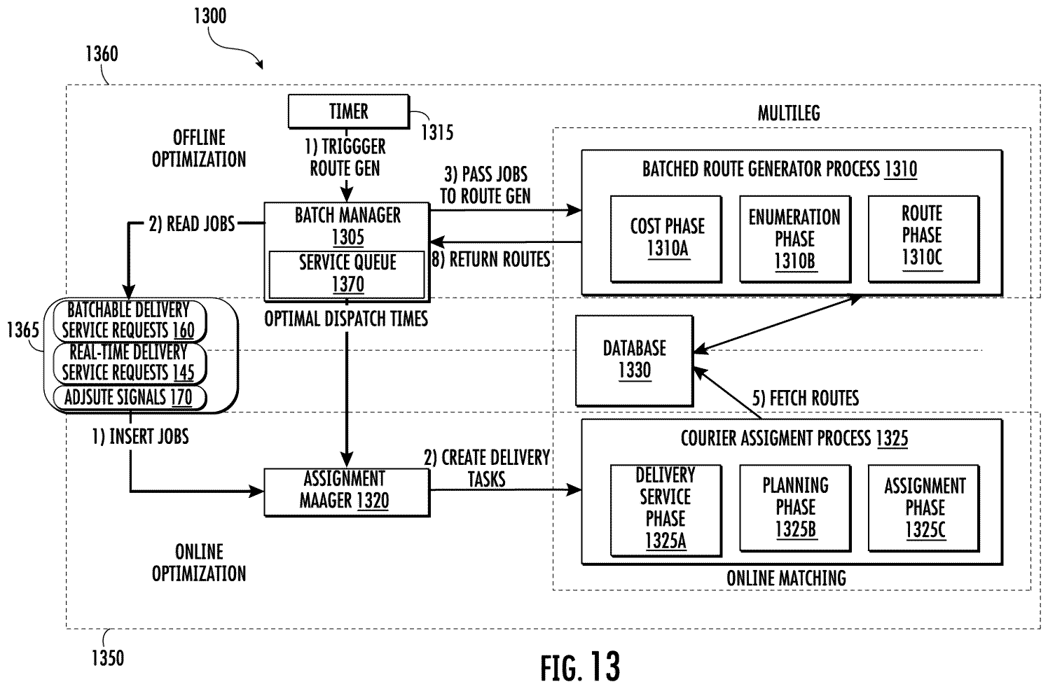

FIG. 13 depicts a block diagram for a hybrid delivery system 1300 according to aspects of the present disclosure. The hybrid delivery system 1300 can include a number of subsystems, software modules, or computing tools that enable the implementation of a hybrid delivery service that integrates a real-time courier matching process 1350 with a pre-matching batch analysis process 1360.

The pre-matching batch analysis process 1360 can include a vertical-agnostic matching solution that can generate batched routes of a number of device services. This can include, for example, five to upwards of ten delivery services. The hybrid delivery system 1300 can combine the real-time courier matching process 1350 with a pre-matching batch analysis process 1360 for an ensemble approach of route generation.

The pre-matching batch analysis process 1360 can provide a number of computational improvements and technical effects. The pre-matching batch analysis process 1360 can be implemented as an offline process to avoid unnecessary computational complexity associated with generating batched routes and allow the hybrid delivery system 1300 more compute time to generate and select a number of batched routes for eligible delivery requests. As such, the technology of the present disclosure can help reduce the number of computational resources (and improve computational efficiency) for generating batched routes for a large number of delivery services.

Moreover, by introducing the pre-matching batch analysis process 1360 as an offline flow, the hybrid delivery system 1300 can allow more compute time (up to 15 minutes rather than less than 30 seconds) to generate and select a number of batched routes for eligible delivery requests. The batched routes can be cached and merged into the real-time courier matching process 1350 when it comes time to dispatch the couriers to complete the delivery services. This can lead to more efficient courier routing as well as less courier downtime, improving fuel consumption and reducing the computational resources used on the courier device that can otherwise be used for inefficient route determinations.

During the pre-matching batch analysis process 1360, the hybrid delivery system 1300 can access delivery data indicative of a number of delivery attributes for at least a subset of a number of delivery services that are available for batch delivery assessment. The subset of delivery services can include a number of batchable delivery service requests 160. The hybrid delivery system 1300 can access the batchable delivery service requests 160 based on state data for a number of delivery service requests received by the hybrid delivery system 1300.

The state data for the number of delivery service requests can identify a type of delivery service and timing information associated with the delivery service for each of the delivery service requests.

A delivery service can be associated with different service types according to example embodiments of the present disclosure. A delivery service can be one of at least three service types including: (i) a real-time service; (ii) a scheduled service; or (iii) a batchable service. Each service type can be associated with one or more different time-based states that are reflective of a respective delivery service's progress within a delivery process stream. A delivery service can be transitioned between states to reflect the current status of the delivery service with respect to tasks that can be performed to facilitate the service.

A real-time service can include a delivery service that is requested to be performed as soon as possible. The real-time service, for example, can include delivery services for perishable items such as food items. The real-time service can be associated with a created state, an active state, an assigned state, and an unassigned state. These states are not mutually exclusive. The real-time service can be assigned one or more of the states at any given point before the completion of the real-time service.

The real-time service can be created in response to a request for the real-time service. Upon creation, the real-time service can be assigned at least one of the created state or the unassigned state. The real-time service can remain in the created state until the real-time service is offered to one or more couriers at which time the real-time service can be assigned an active state. During the active state, the real-time service can be assigned to a courier for performance and, in response, can be assigned an assigned state. The real-time service can remain in the active state until the courier completes performance of the real-time service.

A scheduled service can include a delivery service that is requested to be performed at a scheduled time after the request for delivery service is received. The scheduled service, for example, can include transportation services at a designated time. The scheduled service can be associated with a created state, an active state, a queued state, an unassigned state, and an assigned state. These states are not mutually exclusive. The scheduled service can be assigned one or more of the states at any given point before the completion of the scheduled service.

The scheduled service can be created in response to a request for the scheduled service. Upon creation, the scheduled service can be assigned the created state.

The scheduled service can be added to a delivery queue and be assigned a queued state. The scheduled service can be added to the delivery queue based on a threshold time before the requested service time. The threshold time can be a predetermined static time period before the requested service time. In addition, or alternatively, the threshold time can be a function of the requested service time, historical courier availability information, or any other factor that can contribute to the performance of a delivery service.

The scheduled service can remain in the queued state until the scheduled service is offered to one or more couriers. The scheduled service can be assigned an active state or an unassigned state. During the unassigned state, the scheduled service can be assigned to a courier for performance and, in response, can be assigned an assigned state. The scheduled service can remain in the active state until the courier completes performance of the scheduled service.

The batch eligible service can include a delivery service that satisfies one or more criteria for a prematching batch process. The criteria, for example, can include scheduled services with: (i) long delivery windows, or (ii) long delivery lead time. The long delivery windows, for example, can include a thirty minute to two hour minimum delivery window to allow flexibility around batching. The long delivery lead time can include a two hour minimum lead time to allow sufficient time for offline planning.

The batch eligible service can be created in response to a request for the scheduled service that satisfies the one or more criteria for a prematching batch process. In the event the scheduled service does satisfy the one or more criteria for a prematching batch process, the delivery service can be flagged as a batch eligible service. The batch eligible service can be associated with a created state, an active state, a batching state, an unassigned state, or an assigned state. These states are not mutually exclusive. The batch eligible service can be assigned one or more of the states at any given point before the completion of the batch eligible service.

Upon creation, the batch eligible service can be assigned the created state.

The batch eligible service can be selected for batching and be assigned a batching state. The batch eligible service can be selected for batching based on a threshold time before a requested service time. The threshold time can be a predetermined static time period before the requested service time. In addition, or alternatively, the threshold time can be a function of the requested service time, historical courier availability information, or any other factor that can contribute to the performance of a delivery service.

The batch eligible service can remain in the batching state until the batch eligible service is offered to one or more couriers. The batch eligible service can be provided to one or more couriers at the earliest dispatch time available for: (i) the batch eligible service or (ii) another delivery service that is batched with the batch eligible service. Route data of a batched route for performing the batch eligible service and the other services batched with the batch eligible service can be provided to one or more couriers. At this time the batched route can be locked, and the batch eligible service can be assigned to an unassigned state.

The batch eligible service can be assigned an active state. During the active state and the unassigned state, the batch eligible service can be assigned to a courier for performance and, in response, can be assigned an assigned state. The batch eligible service can remain in the active state until the courier completes performance of the scheduled service.

The hybrid delivery system 1300 can access the batchable delivery service requests 160 by obtaining delivery service requests of a batch eligible service type that are created and unassigned. For example, the batch manager 1305 can access delivery data for the batchable delivery service requests 160 from the memory 1365. The batch manager 1305 can analyze delivery data for each of the number of batchable delivery service requests 160 during the pre-matching batch analysis process 1360 to dynamically update a service queue 1370 that includes a number of precomputed batched routes accounting for each of the number of batchable delivery service requests 160.

For example, the batch manager 1305 can provide the delivery data for the batchable delivery service requests 160 to a pre-matching batch analysis process 1360 to generate a batched route for at least two delivery services of the delivery services that are batch eligible. The batched route can include one or more pick-up locations, a number of destination locations, timing information for arriving at the pickup/drop-off locations, and item characteristics for each of the at least two delivery services of the batched route.

For example, the batched route can include pick-up and drop-off locations for each item of a requested delivery service included in the batched route. Each delivery service can include one or more pickup/drop-off locations. In some implementations, a delivery service can include one pick-up location and a number of drop-off locations. In some implementations, a delivery service can include a number of pick-up locations and a number of drop-off locations.

Additionally, the batched route can include timing information for arriving at the pickup/drop-off locations for the delivery services performed by the batched route. The timing information can include a time period for arriving at each of the pickup/drop-off locations of the batched route.

As another example, the batched route can include item characteristics for each of the at least two delivery services of the batched route. The item characteristics can include a threshold item capacity that can be descriptive of an aggregate weight, size, or dimensions of the items requested to be transported by the at least two delivery services of the batched route.

In some implementations, the batch manager 1305 can determine additional batchable delivery service requests would help improve computation resource utilization. As such, adjusted signals 170 can be generated to determine time windows, merchants, or geographic zones or subzones that should be provided with nudges to increase delivery service requests.

In some implementations, the batched route can include a status. The status can indicate whether the batched route can be dispatched or modified. A batched route can have a locked status, for example, indicating that the batched route is unmodifiable or is ready to be assigned to a courier. In addition, or alternatively, the batched route can have a modifiable status indicating that the batched route is not ready to be assigned to a courier and can be modified. The status for the batched route can be used to transition the batched route from the pre-matching batch analysis process 1360 to the real-time courier matching process 1350.

By way of example, the status for the batched route can be changed based on a state change associated with a delivery service of the batched route. For instance, the status for the batched route can change from a modifiable status to a locked status in response to a delivery service's state changing to an unassigned state.

The batched route can be generated based on the delivery attributes for the number of delivery services. The delivery attributes, for example, can include at least one pick-up location and at least one drop-off location for a respective delivery service. In some implementations, a respective delivery service can include a number of pick-up and drop-off locations.

In addition, or alternatively, the number of delivery attributes can include item characteristics associated with a respective delivery service. The item characteristics can include a weight, a size, or one or more dimensions for a respective item associated with the delivery service. In some implementations, the number of delivery attributes can include a perishability of the respective item associated with the delivery service. Item characteristics can be descriptive of one individual item or an aggregate of several items or each item in a group of items. For example, the item characteristics can be indicative of a total size and shape of a group of food item boxes, when all stacked together. Additionally, or alternatively, the item characteristics can indicate the respective size/shape of an individual box and a number thereof. In some implementations, the item characteristics (e.g., size, shape, etc.) can be descriptors, referential phrases representative of the characteristics (e.g., “T-shirt sized boxes”). In some implementations, the item characteristics can be based on predetermined stored information. For example, a service provider can have a canonical product catalog of characteristics for items. The catalog can be stored digitally and can be adjustable overtime. The item characteristics can be descriptive of the information in the catalog.

The number of delivery attributes can include timing constraints for the batched delivery service. The timing constraints can specify a loading duration that is indicative of a loading time or an unloading time for a respective item associated with the delivery service. In addition, or alternatively, the number of delivery attributes can include a delivery time range for the delivery service. In some implementations, the delivery time range can be based on the perishability of the respective item associated with the delivery service.

In some implementations, a delivery time for the batched route can be determined based on the delivery time range or the loading duration for the delivery services of the batched route.

The number of batched routes of the service queue 1370 can be reconfigured during a batched route generator process 1310 at a predetermined time interval. For instance, the hybrid delivery system 1300 can include a memory 1365 storing pending delivery requests for implementation by the hybrid delivery system 1300. The memory 1365 can include a short term cache memory, a long term secondary memory, etc.

The pending delivery requests can include real-time delivery service requests 145 and batchable delivery service requests 160 that are assigned a respective created state. At the predetermined time interval, the hybrid delivery system 1300 can retrieve the pending batchable delivery service requests 160 for a particular area to reconfigure the number of batched routes of the service queue 1370.

For example, the hybrid delivery system 1300 can include a timer 1315 that can produce a recurring trigger to kick off the batched route generator process 1310. The timer 1315, for example, can issue an instruction to the batch manager 1305 at a predetermined or dynamically determined time interval to initiate the batched route generator process 1310. The time interval, for example, can include a thirty minute scan time interval. In some implementations, the timer 1315 can dynamically determine the time interval based on a respective geographic area associated with the delivery services, an availability of couriers in the geographic area, a demand for deliveries in the geographic area, or any other characteristics than can impact the computational complexity for generating batched routes that account for the delivery services requested in the geographic area.

The pre-matching batch analysis process 1360 can include a batched route generator process 1310 that can include a number of phases. The phases can include a cost phase 1310A, an enumeration phase 1310B, and a route phase 1310C.

During the cost phase 1310A, the hybrid delivery system 1300 can determine one or more delivery service groups from the subset of delivery services based on the pick-up locations and drop-off locations for the delivery services. For example, the hybrid delivery system 1300 can generate a cost matrix that is descriptive of the time or distance values for every location corresponding to each of the batchable delivery services. The hybrid delivery system 1300 can generate one or more delivery service groups based on the cost matrix. Each delivery service group can include one or more delivery services that include a pickup/drop-off time and location that are within a determined distance or travel time of one another.

During the enumeration phase 1310B, the hybrid delivery system 1300 can generate a number of candidate routes for the subset of delivery services based on the one or more delivery service groups. For instance, the hybrid delivery system 1300 can iteratively determine a number of candidate routes for each of the delivery service groups. For example, the hybrid delivery system 1300 can use a number of heuristics to reduce the number of routes to explore.

The heuristics, for example, can analyze the number of delivery attributes to generate a number of candidate routes that are feasible and reduce courier time. The heuristics can include a relative route distance threshold, a pickup/drop-off duration, a threshold item capacity, etc. The heuristics can be used to minimize an aggregate courier time across the batched delivery services to determine the number of candidate routes. The candidate routes can be scored based on an amount of courier time saved and a flexibility of adherence to the candidate route.

In some implementations, the heuristics can be used to increase the number of couriers that can perform a batch route. As one example, the hybrid delivery system 1300 can determine a threshold item capacity for a delivery service based on an aggregate item weight, item size, and item dimensions for the respective items associated with the delivery service. The hybrid delivery system 1300 can generate the batched route based on the threshold item capacity. By way of example, the hybrid delivery system 1300 can match different delivery services to reduce the threshold item capacity for the batched route in order to increase the number of couriers that can physically perform the batched route.

During the route phase 1310C, the hybrid delivery system 1300 can select the batched route from the number of candidate routes based on an aggregated driving time associated with one or more combinations of the number of candidate routes. The batched route can be assigned a unique identifier and route data for the batched route can be stored to the bridge database 1330. The bridge database 1330, for example, can include a database that is accessible to both the real-time courier matching process 1350 and the pre-matching batch analysis process 1360. The unique identifier can be stored in the service queue 1370. The unique identifier can be used to retrieve the route data from the bridge database 1330.

The hybrid delivery system 1300 can update the service queue 1370 based on the batched route. For instance, the service queue can include a number of precomputed routes associated with the subset of delivery services that were computed during a previous time interval. During a current time interval, the hybrid delivery system 1300 can generate, based on the batched route, a number of additional batched routes that account for each batchable delivery service of the subset of delivery services. Each of the additional batched routes can be assigned a unique identifier and route data for the batched routes can be stored to the bridge database 1330. The service queue 1370 can be updated by replacing the number of precomputed routes with the unique identifiers of the number of batched routes generated during the current time interval.

In some implementations, the hybrid delivery system 1300 can determine a delivery time for each of the number of batched routes. The delivery time for a respective batched route, for example, can include the earliest requested delivery time for the delivery services of the respective batched route. The hybrid delivery system 1300 can update the service queue based on the delivery time for each of the number of batched routes by ordering the number of batched routes in accordance with the delivery times.

The hybrid delivery system 1300 can detect, based on the state data, a state change that is associated with a delivery service associated with the batched route. The state change can include a transition from a created state to an active state. In response to the state change, hybrid delivery system 1300 can perform the real-time courier matching process 1350 with the batched route.

The real-time courier matching process 1350 can include a courier assignment process 1325 in which a courier is assigned to perform the batched route. The courier assignment process can include a delivery service phase 1325A, a planning phase 1325B, and an assignment phase 1325C.

During the delivery service phase 1325A, the hybrid delivery system 1300 can fetch delivery tasks from the assignment manager 1320. The assignment manager 1320 can receive the delivery tasks from the memory 1365 at a short-term time interval (e.g., fifteen seconds, etc.). At each short-term time interval, the assignment manager 1320 can receive delivery data for pending real-time delivery service requests 145 and batchable delivery service requests 160. Each delivery task can be indicative of: (i) a delivery service corresponding to a real-time delivery service request 145, (ii) a number of delivery services corresponding to a batched route, or (iii) a hybrid combination of a real-time delivery service corresponding to a real-time delivery service request 145 and a number of delivery services corresponding to a batched route. During the delivery service phase 1325A, the hybrid delivery system 1300 can fetch the delivery tasks from the assignment manager 1320 that are ready to be assigned to a courier (e.g., include an active status).

During the planning phase 1325B, hybrid delivery system 1300 can generate full supply plans based on route information stored at the bridge database 1330. For example, the hybrid delivery system 1300 can access the bridge database 1330 to enrich the retrieved delivery tasks. By way of example, each of the delivery tasks can include a unique identifier corresponding to a real-time delivery service or a batched route. The hybrid delivery system 1300 can retrieve route data for a delivery task by searching the bridge database 1330 using a respective unique identifier. When the hybrid delivery system 1300 enriches the retrieved delivery tasks, the hybrid delivery system 1300 can pull information on whether or not each delivery task is a batched task with a corresponding batched route. For every batched task, the hybrid delivery system 1300 can have a flag identifying the task as a batched task. The batched route for a batched task can be modified based on real-time vehicle data and an updated estimated time of arrival for each of the pick-up and drop-off locations of the batched route can be calculated.

During the assignment phase 1325C, the hybrid delivery system 1300 can match the batched plans to eligible couriers. For example, the hybrid delivery system 1300 can access real-time vehicle data indicative of an availability of one or more vehicles within the geographic area. The availability of the one or more vehicles can be based on one or more assignments for the vehicle(s) or a capacity of the vehicle(s). For instance, the real-time vehicle data can be indicative of one or more previously or concurrently assigned delivery services. In addition, or alternatively, the real-time vehicle data can be indicative of a capacity for the one or more vehicles.

By way of example, the capacity of a vehicle can be based on a vehicle/courier type. The vehicle/courier type can be descriptive of at least one of an automobile, a bicycle, a scooter, or a human. In addition, or alternatively, the vehicle/courier type can be descriptive of a type of automobile (e.g., sedan, coupe, sports-utility vehicle, van, truck, etc.). Each vehicle/courier type can be associated with a respective capacity.

In some implementations, the real-time vehicle data can be indicative of a current driving assignment for a respective vehicle and the capacity of the respective vehicle can be based on the current driving assignment and the vehicle type. For instance, the capacity of the respective vehicle can be the capacity associated with the vehicle type minus the capacity occupied by the items of the current driving assignment.

The hybrid delivery system 1300 can communicate, based on the real-time vehicle data, data indicative of the batched route to one or more vehicles during courier assignment process 1325. The data indicative of the batched route can be communicated to each of a subset of vehicles that are available to perform the batched route. In some implementations, the availability of the subset of vehicles can be based on the capacity of the vehicles. For instance, the hybrid delivery system 1300 can determine that the capacity of the vehicles accommodates the threshold item capacity for the batched route. The hybrid delivery system 1300 can communicate the data indicative of the batched route to the vehicles based on the determination that the capacity of the vehicles accommodates the threshold item capacity for the batched route.

In some implementations, the hybrid delivery system 1300 can communicate the data indicative of the batched route through a respective courier interface accessible by an available courier.

In some implementations, the hybrid delivery system 1300 can communicate the data indicative of the batched route by modifying a shared data structure accessible to a number of couriers via a respective courier interface. For instance, the hybrid delivery system 1300 can add the indication of the batched route to an offline delivery board accessible by an available courier (e.g., operator of an available vehicle). The offline delivery board can include a number of batched routes that are ready to be assigned to the courier. The offline delivery board can be shared by a number of couriers such that multiple couriers can simultaneously view the batched routes at the same time.

The indication of the batched route can be selectable (or include an interactive widget) by a courier to view additional details. For example, the hybrid delivery system 1300 can receive data indicative of a selection of the batched route by a courier (e.g., an operator of an available vehicle). In response to the selection, the hybrid delivery system 1300 can communicate additional route data for the selected batched route to the courier.

The route data for the batched route can be descriptive of: (i) a respective drop-off and pick-up location for each of the at least two delivery services of the batched route, (ii) an order for arriving at the respective drop-off and pick-up location for each of the at least two delivery services of the batched route, (iii) a route between the respective drop-off and pick-up location for each of the at least two delivery services of the batched route, or (iv) timing information for a performance of each of the at least two delivery services of the batched route.

In some implementations, the route data can be displayed, in response to the selection of the batched route, to the courier via an interactive map interface. By way of example, the interactive map interface can depict the batched route and can include an interactive widget for each pick-up and drop-off location of the batched route. A widget can be selectable to provide pickup/drop-off information for a respective location such as, for example, an estimated loading/unloading duration, a weight, size, or one or more dimensions for a respective item to be loaded/unloaded, an estimated time of arrival at the respective location, etc.

In some implementations, the data indicative of the batched route can be abstracted out and constructed or modified while the courier performs the batched route. For example, the abstracted batched route can include an estimated final destination and a next stop. The next stop can be modifiable to incorporate real-time delivery services to different portions of the batched route. For example, the batched route can be modified to add an additional pick-up location to service a recently received real-time delivery service request. In this manner, the batched route can be combined with real-time service requests to improve courier efficiency.

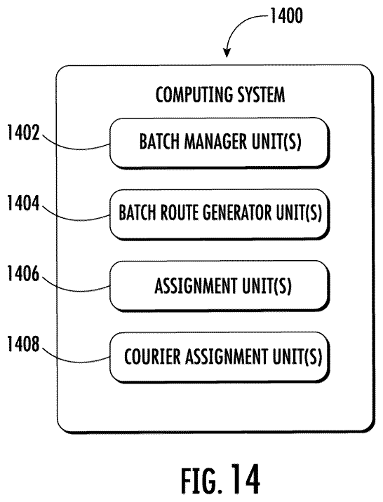

Various means can be configured to perform the methods and processes described herein. For example, FIG. 14 depicts an example system 1400 that includes various means according to example embodiments of the present disclosure. The computing system 1400 can be or otherwise include, for example, an operations computing system, etc. The computing system 1400 can include data batch manager unit(s) 1402, batch route generator unit(s) 1404, assignment unit(s) 1406, courier assignment unit(s) 1408, or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), or other suitable hardware.

The means can be programmed to perform one or more algorithm(s) for carrying out the operations and functions described herein. For instance, the means (e.g., batch manager unit(s) 1402) can be configured to access, based on state data for a number of delivery services, delivery data indicative of a number of delivery attributes for at least a subset of the number of delivery services that are available for batch delivery assessment.

In addition, the means (e.g., batch route generator unit(s) 1404) can be configured to generate a batched route for at least two delivery services of the subset of delivery services based on the delivery data. The batched route can include one or more pick-up locations and a number of destination locations corresponding to the at least two delivery services.

In some implementations, the means (e.g., the batch manager unit(s) 1402) can update, based on the batched route, a service queue including a number of precomputed routes associated with the subset of delivery services.

The means (e.g., assignment unit(s) 1406) can be configured to detect, based on the state data, a state change that is associated with a delivery service associated with the batched route.

The means (e.g., courier assignment unit(s) 1408) can be configured to, in response to the state change, access real-time vehicle data indicative of an availability of one or more vehicles. In addition, or alternatively, the means (e.g., courier assignment unit(s) 1408) can be configured to communicate, based on the real-time vehicle data, data indicative of the batched route to at least one vehicle of the number of vehicles.

These described functions of the means are provided as examples and are not meant to be limiting. The means can be configured for performing any of the operations and functions described herein.

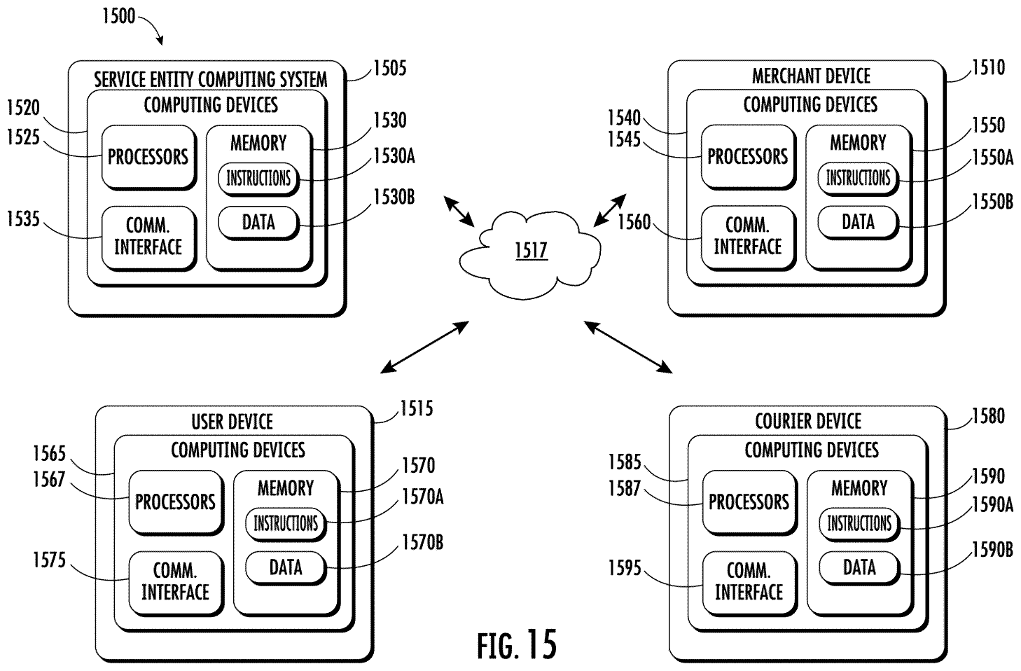

FIG. 15 depicts a block diagram of an example system 1500 for implementing systems and methods according to example embodiments of the present disclosure. The example system 1500 illustrated in FIG. 15 is provided as an example only. The components, systems, connections, or other aspects illustrated in FIG. 15 are optional and are provided as examples of what is possible, but not required, to implement the present disclosure. The example system 1500 can include a service entity computing system 1505 (e.g., that is associated with a delivery service entity). The example system 1500 can include one or more merchant devices 1510 (e.g., that is associated with a merchant). The example system 1500 can include one or more user devices 1515 (e.g., user device of the user, user device of the operator, user device of the vehicle). The example system 1500 can include one or more courier devices (e.g., a display device positioned on the exterior of a vehicle). One or more of the service entity computing system 1505, the merchant device 1510, the user device 1515, or the courier device can be communicatively coupled to one another over one or more communication network(s) 1517. The networks 1517 can correspond to any of the networks described herein.

The computing device(s) 1520 of the service entity computing system 1505 can include processor(s) 1525 and a memory 1530. The one or more processors 1525 can be any suitable processing device (e.g., a processor core, a microprocessor, an ASIC, a FPGA, a controller, a microcontroller) and can be one processor or a number of processors that are operatively connected. The memory 1530 can include one or more non-transitory computer-readable storage media, such as RAM, ROM, EEPROM, EPROM, one or more memory devices, flash memory devices, data registrar, etc., and combinations thereof.

The memory 1530 can store information that can be accessed by the one or more processors 1525. For example, the memory 1530 (e.g., one or more non-transitory computer-readable storage mediums, memory devices) can include computer-readable instructions 1530A that can be executed by the one or more processors 1525. The instructions 1530A can be software written in any suitable programming language or can be implemented in hardware. Additionally, or alternatively, the instructions 1530A can be executed in logically or virtually separate threads on processor(s) 1525.

For example, the memory 1530 can store instructions 1530A that when executed by the one or more processors 1525 cause the one or more processors 1525 (the service entity computing system 1505) to perform operations such as any of the operations and functions of the computing system(s) (e.g., operations computing system) described herein (or for which the system(s) are configured), one or more of the operations and functions for communicating between the computing systems, one or more portions/operations of method 1100, or one or more of the other operations and functions of the computing systems described herein.

The memory 1530 can store data 1530B that can be obtained (e.g., acquired, received, retrieved, accessed, created, stored). The data 1530B can include, for example, any of the data/information described herein. In some implementations, the computing device(s) 1520 can obtain data from one or more memories that are remote from the service entity computing system 1505.

The computing device(s) 1520 can also include a communication interface 1535 used to communicate with one or more other system(s) remote from the service entity computing system 1505, such as merchant device 1510, user device 1515, or courier device 1580. The communication interface 1535 can include any circuits, components, software, etc. for communicating via one or more networks (e.g., network(s) 1517). The communication interface 1535 can include, for example, one or more of a communications controller, receiver, transceiver, transmitter, port, conductors, software or hardware for communicating data.

The merchant device 1510 can include one or more computing device(s) 1540 that are remote from the service entity computing system 1505, the user device 1515, and the courier device 1580. The computing device(s) 1540 can include one or more processors 1545 and a memory 1550. The one or more processors 1545 can be any suitable processing device (e.g., a processor core, a microprocessor, an ASIC, a FPGA, a controller, a microcontroller) and can be one processor or a number of processors that are operatively connected. The memory 1550 can include one or more tangible, non-transitory computer-readable storage media, such as RAM, ROM, EEPROM, EPROM, one or more memory devices, flash memory devices, data registrar, etc., and combinations thereof.

The memory 1550 can store information that can be accessed by the one or more processors 1545. For example, the memory 1550 (e.g., one or more tangible, non-transitory computer-readable storage media, one or more memory devices) can include computer-readable instructions 1550A that can be executed by the one or more processors 1545. The instructions 1550A can be software written in any suitable programming language or can be implemented in hardware. Additionally, or alternatively, the instructions 1550A can be executed in logically or virtually separate threads on processor(s) 1545.

For example, the memory 1550 can store instructions 1550A that when executed by the one or more processors 1545 cause the one or more processors 1545 to perform operations such as any of the operations and functions of the computing system(s) (e.g., merchant server) described herein (or for which the system(s) are configured), one or more of the operations and functions for communicating between computing systems, one or more portions/operations of method 1100, or one or more of the other operations and functions of the computing systems described herein. The memory 1550 can store data 1550B that can be obtained. The data 1550B can include, for example, any of the data/information described herein.

The computing device(s) 1540 can also include a communication interface 1560 used to communicate with one or more system(s) that are remote from the merchant device 1510. The communication interface 1560 can include any circuits, components, software, etc. for communicating via one or more networks (e.g., network(s) 1517). The communication interface 1560 can include, for example, one or more of a communications controller, receiver, transceiver, transmitter, port, conductors, software or hardware for communicating data.

The user device 1515 can include one or more computing device(s) 1565 that are remote from the service entity computing system 1505, the merchant device 1510, and the courier device 1580. The computing device(s) 1565 can include one or more processors 1567 and a memory 1570. The one or more processors 1567 can be any suitable processing device (e.g., a processor core, a microprocessor, an ASIC, a FPGA, a controller, a microcontroller) and can be one processor or a number of processors that are operatively connected. The memory 1570 can include one or more tangible, non-transitory computer-readable storage media, such as RAM, ROM, EEPROM, EPROM, one or more memory devices, flash memory devices, data registrar, etc., and combinations thereof.

The memory 1570 can store information that can be accessed by the one or more processors 1567. For example, the memory 1570 (e.g., one or more tangible, non-transitory computer-readable storage media, one or more memory devices) can include computer-readable instructions 1570A that can be executed by the one or more processors 1567. The instructions 1570A can be software written in any suitable programming language or can be implemented in hardware. Additionally, or alternatively, the instructions 1570A can be executed in logically or virtually separate threads on processor(s) 1567.

For example, the memory 1570 can store instructions 1570A that when executed by the one or more processors 1567 cause the one or more processors 1567 to perform operations such as any of the operations and functions of the computing system(s) (e.g., user devices) described herein (or for which the user device(s) are configured), one or more of the operations and functions for communicating between systems, one or more portions/operations of method 1100, or one or more of the other operations and functions of the computing systems described herein. The memory 1570 can store data 1570B that can be obtained. The data 1570B can include, for example, any of the data/information described herein.

The computing device(s) 1565 can also include a communication interface 1575 used to communicate computing device/system that is remote from the user device 1515, such as merchant device 1510, service entity computing system 1505, or courier device 1580. The communication interface 1575 can include any circuits, components, software, etc. for communicating via one or more networks (e.g., network(s) 1517). The communication interface 1575 can include, for example, one or more of a communications controller, receiver, transceiver, transmitter, port, conductors, software or hardware for communicating data.

The computing device(s) 1585 of the courier device 1580 can include processor(s) 1587 and a memory 1590. The one or more processors 1587 can be any suitable processing device (e.g., a processor core, a microprocessor, an ASIC, a FPGA, a controller, a microcontroller) and can be one processor or a number of processors that are operatively connected. The memory 1590 can include one or more non-transitory computer-readable storage media, such as RAM, ROM, EEPROM, EPROM, one or more memory devices, flash memory devices, data registrar, etc., and combinations thereof.

The memory 1590 can store information that can be accessed by the one or more processors 1587. For example, the memory 1590 (e.g., one or more non-transitory computer-readable storage mediums, memory devices) can include computer-readable instructions 1590A that can be executed by the one or more processors 1587. The instructions 1590A can be software written in any suitable programming language or can be implemented in hardware. Additionally, or alternatively, the instructions 1590A can be executed in logically or virtually separate threads on processor(s) 1587.

For example, the memory 1590 can store instructions 1590A that when executed by the one or more processors 1587 cause the one or more processors 1587 (the courier device 1580) to perform operations such as any of the operations and functions of the display device(s) described herein (or for which such devices are configured), one or more of the operations and functions for communicating between the computing systems/devices, one or more portions/operations of method 1100, or one or more of the other operations and functions of the computing systems described herein.

The memory 1590 can store data 1590B that can be obtained (e.g., acquired, received, retrieved, accessed, created, stored). The data 1590B can include, for example, any of the data/information described herein. In some implementations, the computing device(s) 1585 can obtain data from one or more memories that are remote from the courier device 1580.

The computing device(s) 1585 can also include a communication interface 1595 used to communicate with one or more other system(s) remote from the courier device 1580, such as merchant device 1510, user device 1515, or service entity computing system 1505. The communication interface 1595 can include any circuits, components, software, etc. for communicating via one or more networks (e.g., network(s) 1517). The communication interface 1595 can include, for example, one or more of a communications controller, receiver, transceiver, transmitter, port, conductors, software or hardware for communicating data.

The network(s) 1517 can be any type of network or combination of networks that allows for communication between devices. In some implementations, the network(s) 1517 can include one or more of a local area network, wide area network, the Internet, secure network, cellular network, mesh network, peer-to-peer communication link or some combination thereof and can include any number of wired or wireless links. Communication over the network(s) 1517 can be accomplished, for example, via a communication interface using any type of protocol, protection scheme, encoding, format, packaging, etc.

Computing tasks discussed herein as being performed at certain computing device(s)/systems can instead be performed at another computing device/system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative embodiments thereof. Numerous other embodiments, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, refers to “and/or”, “at least one of”, or “any combination of” example elements listed therein. Also, terms such as “based on” should be understood as “based at least in part on”.

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral, for example illustrated purposes and are not meant to be limiting.

1. A computing system comprising:
one or more processors;
one or more non-transitory computer readable media storing instructions that are executable by the one or more processors to perform operations, the operations comprising:
accessing data associated with a first batch delivery window, the first batch delivery window comprising a plurality of batched service instances, the data comprising at least a first service instance of the plurality of batched service instances, the first service instance comprising a pick-up location, a drop-off location, and a drop-off time range, wherein the drop-off time range is within the first batch delivery window;
determining, based on prior history data associated with prior real-time orders associated with a first device identifier, a first probability that the first device identifier initiates a second service instance associated with the pick-up location outside of the first batch delivery window is greater than a second probability that the first device identifier initiates the second service instance associated with the pick-up location within the first batch delivery window;
based on determining that the first probability is greater than the second probability, determining a selected incentive predicted to increase the second probability associated with initiating the second service instance associated with the pick-up location within the first batch delivery window;
generating a selectable user interface element comprising an indication of the incentive associated with the first batch delivery window;
responsive to obtaining data indicative of selection of the user interface element, automatically updating a user interface associated with a user device to launch a secondary user interface associated with a service application such that the incentive is provided for display alongside a plurality of available items associated with the first batch delivery window;
periodically, using an offline process, determining a set of batched service instances for a plurality of available service instances associated with the first batch delivery window by:
obtaining data associated with the plurality of available service instances;
generating clusters of the plurality of available service instances into subgroups based on at least one of pick-up time, number of items, or metadata associated with the items; and
for each cluster of available service instances, generate a plurality of candidate routes, wherein each respective candidate route of the plurality of candidate routes comprises four or more service instances;
for each respective candidate route of the plurality of generated candidate routes:
evaluating the respective candidate route to determine a plurality of waypoint times associated with the route;
comparing the respective candidate route to one or more constraints;
determining that the respective candidate route either (i) violates at least one of the one or more constraints, or (ii) does not violate any of the one or more constraints; and
responsive to determining that the respective candidate route (i) violates the at least one constraint, discarding the route, or (ii) does not violate any of the one or more constraints, maintaining the route.

2. (canceled)

3. The computing system of claim 1, wherein the one or more constraints comprises at least a time window constraint. (Original) The computing system of claim 3, the operations comprising:
generating the time window constraint by:
computing an estimated time of arrival between each waypoint of the plurality of waypoints of the respective candidate route; and
for each waypoint of the plurality of waypoints computing an earliest timestamp and a latest timestamp.

5. The computing system of claim 4, the operations comprising:
determining an estimated time of arrival for a current waypoint based on a task time associated with the current waypoint and a travel time between a previous waypoint and the current waypoint;
determining that the earliest timestamp and the latest timestamp are indicative of a courier arriving at least one of: (i) too early or (ii) too late; and
responsive to determining that the earliest timestamp and the latest timestamp are indicative of the courier arrive at least one of: (i) too early or (ii) too late, discarding the respective candidate route from the plurality of candidate routes.

6. The computing system of claim 1, the operations comprising:
selecting a subset of routes of the plurality of candidate routes, wherein the subset of routes are selected such that each service instance is associated with no more than one route; and
for each selected route, determining an earliest dispatch time and a latest dispatch time for all service instances associated with the selected route based at least in part on a route dispatch time.

7. The computing system of claim 6, the operations comprising:
responsive to determining that a current time is between the earliest dispatch time and the latest dispatch time, accessing a datastore comprising a plurality of candidate couriers and current locations of the respective candidate couriers;
assigning, based on the current location of a plurality of candidate couriers and an estimated arrival time to a first waypoint of the first service instance of the selected route, a first courier to perform the batched route; and
automatically transmitting instructions which cause a device associated with the first courier to display information associated with the batched route.

8. The computing system of claim 1, wherein the incentives comprise at least one of: (i) a discount, (ii) a reward, or (iii) a metric of an amount of carbon dioxide usage reduced by selecting a drop-off time within the first batch delivery window.

9. The computing system of claim 8, the operations comprising:
determining the metric of an amount of carbon dioxide usage reduced by:
summing a distance of each service instance of the plurality of service instances in the batch route;
determining a difference by subtracting a batched delivery distance comprising a sum of the distances between each waypoint of the batched delivery from the sum of the distance of each service instance;
dividing the difference by a number of individual service instances; and
multiplying the distance saved by a known carbon dioxide footprint value associated with a unit of distance.

10. The computing system of claim 1, wherein determining the selected incentive predicted to increase probability associated with initiating the second service instance associated with the pick-up location within the first batch delivery window comprises:
determining a plurality of candidate incentives;
determining that a first incentive of the plurality of candidate incentives causes a probability adjustment comprising the second probability to exceed the first probability based on device identifier profile data; and
selecting the first incentive based on the probability adjustment.

11. The computing system of claim 1, wherein the selected incentive is determined based on user profile data.

12. A computer-implemented method, the method comprising:
accessing data associated with a first batch delivery window, the first batch delivery window comprising a plurality of batched service instances, the data comprising at least a first service instance of the plurality of batched service instances, the first service instance comprising a pick-up location, a drop-off location, and a drop-off time range, wherein the drop-off time range is within the first batch delivery window;
determining, based on prior history data associated with prior real-time orders associated with a first device identifier, a first probability that the first device identifier initiates a second service instance associated with the pick-up location outside of the first batch delivery window is greater than a second probability that the first device identifier initiates the second service instance associated with the pick-up location within the first batch delivery window;
based on determining that the first probability is greater than the second probability, determining a selected incentive predicted to increase the second probability associated with initiating the second service instance associated with the pick-up location within the first batch delivery window;
generating a selectable user interface element comprising an indication of the incentive associated with the first batch delivery window;
responsive to obtaining data indicative of selection of the user interface element, automatically updating a user interface associated with a user device to launch a secondary user interface associated with a service application such that the incentive is provided for display alongside a plurality of available items associated with the first batch delivery window;
periodically, using an offline process, determining a set of batched service instances for a plurality of available service instances associated with the first batch delivery window by:
obtaining data associated with the plurality of available service instances;
generating clusters of the plurality of available service instances into subgroups based on at least one of pick-up time, number of items, or metadata associated with the items; and
for each cluster of available service instances, generating a plurality of candidate routes, wherein each respective candidate route of the plurality of candidate routes comprises four or more service instances;
for each respective candidate route of the plurality of generated candidate routes:
evaluating the respective candidate route to determine a plurality of waypoint times associated with the route;
comparing the respective candidate route to one or more constraints; and
determining that the respective candidate route either (i) violates at least one of the one or more constraints, or (ii) does not violate any of the one or more constraints; and
responsive to determining that the respective candidate route (i) violates the at least one constraint, discarding the route, or (ii) does not violate any of the one or more constraints, maintaining the route.

13. (canceled)

14. The computer-implemented method of claim 12, wherein the one or more constraints comprises at least a time window constraint.

15. The computer-implemented method of claim 14, the method comprising:
generating the time window constraint by:
computing an estimated time of arrival between each waypoint of the plurality of waypoints of the respective candidate route; and
for each waypoint of the plurality of waypoints computing an earliest timestamp and a latest timestamp.

16. The computer-implemented method of claim 15, the method comprising:
determining an estimated time of arrival for a current waypoint based on a task time associated with the current waypoint and a travel time between a previous waypoint and the current waypoint;
determining that the earliest timestamp and the latest timestamp are indicative of a courier arriving at least one of: (i) too early or (ii) too late; and
responsive to determining that the earliest timestamp and the latest timestamp are indicative of the courier arrive at least one of: (i) too early or (ii) too late, discarding the respective candidate route from the plurality of candidate routes.

17. The computer-implemented method of claim 12, wherein the incentives comprise at least one of: (i) a discount, (ii) a reward, or (iii) a metric of an amount of carbon dioxide usage reduced by selecting a drop-off time within the first batch delivery window.

18. The computer-implemented method of claim 17, wherein determining the selected incentive predicted to increase probability associated with initiating the second service instance associated with the pick-up location within the first batch delivery window comprises:
determining a plurality of candidate incentives;
determining that a first incentive of the plurality of candidate incentives causes a probability adjustment comprising the second probability to exceed the first probability based on device identifier profile data; and
selecting the first incentive based on the probability adjustment.

19. One or more non-transitory computer readable media storing instructions that are executable by one or more processors to perform operations, the operations comprising:
accessing data associated with a first batch delivery window, the first batch delivery window comprising a plurality of batched service instances, the data comprising at least a first service instance of the plurality of batched service instances, the first service instance comprising a pick-up location, a drop-off location, and a drop-off time range, wherein the drop-off time range is within the first batch delivery window;
determining, based on prior history data associated with prior real-time orders associated with a first device identifier, a first probability that the first device identifier initiates a second service instance associated with the pick-up location outside of the first batch delivery window is greater than a second probability that the first device identifier initiates the second service instance associated with the pick-up location within the first batch delivery window;
based on determining that the first probability is greater than the second probability, determining a selected incentive predicted to increase the second probability associated with initiating the second service instance associated with the pick-up location within the first batch delivery window;
generating a selectable user interface element comprising an indication of the incentive associated with the first batch delivery window; and
responsive to obtaining data indicative of selection of the user interface element, automatically updating a user interface associated with a user device to launch a secondary user interface associated with a service application such that the incentive is provided for display alongside a plurality of available items associated with the first batch delivery window;
periodically, using an offline process, determining a set of batched service instances for a plurality of available service instances associated with the first batch delivery window by:
obtaining data associated with the plurality of available service instances;
generating clusters of the plurality of available service instances into subgroups based on at least one of pick-up time, number of items, or metadata associated with the items; and
for each cluster of available service instances, generate a plurality of candidate routes, wherein each respective candidate route of the plurality of candidate routes comprises four or more service instances;
for each respective candidate route of the plurality of generated candidate routes:
evaluating the respective candidate route to determine a plurality of waypoint times associated with the route;
comparing the respective candidate route to one or more constraints;
determining that the respective candidate route either (i) violates at least one of the one or more constraints, or (ii) does not violate any of the one or more constraints; and
responsive to determining that the respective candidate route (i) violates the at least one constraint, discarding the route, or (ii) does not violate any of the one or more constraints, maintaining the route.

20. (canceled)
